(19) United States
(12) Patent Application Publication
(10) Pub. No.: US 2026/0189447 A1
(43) Pub. Date: Jul. 2, 2026

(54) CHANNEL ORIENTED NOISE SHAPING

(71) Applicant: QUALCOMM Incorporated, San Diego, CA (US)

(72) Inventors: Igor GUTMAN, Hod HaSharon (IL); Ariel Yaakov SAGI, Haifa (IL); Tao LUO, San Diego, CA (US); Junyi LI, Fairless Hills, PA (US)

(21) Appl. No.: 19/131,201

(22) PCT Filed: Jan. 18, 2024
(86) PCT No.: PCT/US2024/011957

§ 371 Date: May 19, 2025

(30) Foreign Application Priority Data
Jan. 25, 2023 (IL) 300164

(51) Int. Cl. H04L 27/26

(52) U.S. Cl. CPC H04L 27/2618; H04L 27/2624

(57) ABSTRACT

Methods, systems, and devices for wireless communications are described. A transmitting device may determine channel quality, and may shape frequency domain noise (e.g., crest factor reduction (CFR) related noise) to locations in which channel quality is poor. For example, by shaping channel noise to frequency resources with poor channel quality (e.g., instead of uniformly distributing such channel noise), transmissions may be more reliable, and quality on other frequency resources may be improved (e.g., without negatively impacting the quality of communications via frequency resources that already have a low channel quality), resulting in improved dynamic range of the signal (e.g., peak to average power ratio (PAPR)), which means that power efficiency is improved.

### CROSS REFERENCE

The present application for patent is a 371 national phase filing of International Patent Application No. PCT/US2024/011957, by GUTMAN et al., entitled “CHANNEL ORIENTED NOISE SHAPING,” filed Jan. 18, 2024, which claims priority to Israel Patent Application No. 300164 by GUTMAN et al., entitled “CHANNEL ORIENTED NOISE SHAPING,” filed Jan. 25, 2023, each of which is assigned to the assignee hereof, and each of which is expressly incorporated by reference in its entirety herein.

### FIELD OF TECHNOLOGY

The following relates to wireless communications, including channel oriented noise shaping.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support channel oriented noise shaping. For example, the described techniques provide for a transmitting device determining channel quality, and may shape frequency domain noise to locations in which channel quality is poor. For example, for one or more subbands on which channel quality is poor, the transmitting device may send a transmission according to a low modulation and coding scheme (MCS), as additional channel noise shaped to such subbands may not have a large impact on transmission quality via such subbands. Thus, by shaping channel noise to subbands with poor channel quality (e.g., instead of uniformly distributing such channel noise), the transmissions may be more reliable, and quality on other subbands may be improved (e.g., without negatively impacting the quality of communications via subbands that already have a low channel quality).

A method for wireless communications is described. The method may include shaping a waveform to generate a shaped waveform for transmission by a first wireless device to a second wireless device according to a noise shaping scheme to shape distortion associated with crest factor reduction into one or more sets of frequency resources of a frequency band based on a channel estimate corresponding to the frequency band, transmitting, to the second wireless device, control signaling including an indication of the noise shaping scheme, and transmitting the shaped waveform to the second wireless device via the frequency band based on the noise shaping scheme.

An apparatus for wireless communications is described. The apparatus may include a processor, memory coupled with the processor, and instructions stored in the memory. The instructions may be executable by the processor to cause the apparatus to shape a waveform to generate a shaped waveform for transmission by a first wireless device to a second wireless device according to a noise shaping scheme to shape distortion associated with crest factor reduction into one or more sets of frequency resources of a frequency band based on a channel estimate corresponding to the frequency band, transmit, to the second wireless device, control signaling including an indication of the noise shaping scheme, and transmit the shaped waveform to the second wireless device via the frequency band based on the noise shaping scheme.

Another apparatus for wireless communications is described. The apparatus may include means for shaping a waveform to generate a shaped waveform for transmission by a first wireless device to a second wireless device according to a noise shaping scheme to shape distortion associated with crest factor reduction into one or more sets of frequency resources of a frequency band based on a channel estimate corresponding to the frequency band, means for transmitting, to the second wireless device, control signaling including an indication of the noise shaping scheme, and means for transmitting the shaped waveform to the second wireless device via the frequency band based on the noise shaping scheme.

A non-transitory computer-readable medium storing code for wireless communications is described. The code may include instructions executable by a processor to shape a waveform to generate a shaped waveform for transmission by a first wireless device to a second wireless device according to a noise shaping scheme to shape distortion associated with crest factor reduction into one or more sets of frequency resources of a frequency band based on a channel estimate corresponding to the frequency band, transmit, to the second wireless device, control signaling including an indication of the noise shaping scheme, and transmit the shaped waveform to the second wireless device via the frequency band based on the noise shaping scheme.

In some examples of the method, apparatuses, and non-transitory computer-readable medium described herein, transmitting the control signaling may include operations, features, means, or instructions for transmitting one or more parameters associated with the noise shaping scheme, the one or more parameters including an indication of a shaping filter, an indication of the one or more sets of frequency resources of the frequency band, a peak to average power ratio target, a number of iterations associated with the noise shaping scheme, a transmission power per symbol, or any combination thereof.

In some examples of the method, apparatuses, and non-transitory computer-readable medium described herein, transmitting the control signaling may include operations, features, means, or instructions for transmitting a one-bit indication indicating that distortion filtering according to the noise shaping scheme may be enabled.

Some examples of the method, apparatuses, and non-transitory computer-readable medium described herein may further include operations, features, means, or instructions for receiving, from the second wireless device, an indication of a target error vector magnitude for each of a set of multiple sets of frequency resources including the one or more sets of frequency resources of the frequency band, where shaping the waveform according to the noise shaping scheme may be based on the indication of the target error vector magnitude for each of the set of multiple sets of frequency resources.

In some examples of the method, apparatuses, and non-transitory computer-readable medium described herein, shaping the waveform may include operations, features, means, or instructions for identifying, based on the channel estimate, that channel quality corresponding to the one or more sets of frequency resources may be lower than channel quality corresponding to one or more additional sets of frequency resources of the frequency band and shaping distortion associated with the frequency band to the one or more sets of frequency resources based on the identifying according to the noise shaping scheme.

Some examples of the method, apparatuses, and non-transitory computer-readable medium described herein may further include operations, features, means, or instructions for multiplexing transmissions via a first channel and a second channel, where shaping the distortion includes shaping the distortion to at least a portion of the one or more sets of frequency resources overlapping with the first channel according to a threshold error vector magnitude associated with the first channel.

In some examples of the method, apparatuses, and non-transitory computer-readable medium described herein, shaping the distortion may include operations, features, means, or instructions for shaping the distortion to at least a portion of the one or more sets of frequency resources overlapping with the second channel according to a second threshold error vector magnitude associated with the second channel.

In some examples of the method, apparatuses, and non-transitory computer-readable medium described herein, the first channel includes a physical downlink control channel and the second channel includes a physical downlink shared channel, and the first wireless device includes a network entity.

In some examples of the method, apparatuses, and non-transitory computer-readable medium described herein, the first channel includes a physical uplink control channel and the second channel includes a physical uplink shared channel, and the first wireless device includes a user equipment (UE).

In some examples of the method, apparatuses, and non-transitory computer-readable medium described herein, transmitting the waveform may include operations, features, means, or instructions for transmitting at least a portion of the waveform to a first set of one or more user equipments (UEs) via the one or more sets of frequency resources according to a first error vector magnitude, a first modulation and coding scheme, or both and transmitting at least a portion of the waveform to a second set of one or more UEs via one or more additional sets of frequency resources of the frequency band according to second error vector magnitude, a second modulation and coding scheme, or both.

Some examples of the method, apparatuses, and non-transitory computer-readable medium described herein may further include operations, features, means, or instructions for receiving, from the second wireless device, control signaling including an indication of the one or more sets of frequency resources, a first modulation and coding scheme corresponding to a first error vector magnitude and a second modulation and coding scheme corresponding to a second error vector magnitude, where the first wireless device includes a UE and the second wireless device includes a network entity.

In some examples of the method, apparatuses, and non-transitory computer-readable medium described herein, transmitting the waveform may include operations, features, means, or instructions for transmitting a first portion of the waveform according to the first modulation and coding scheme and the first error vector magnitude and transmitting a second portion of the waveform according to the second modulation and coding scheme and the second error vector magnitude.

Some examples of the method, apparatuses, and non-transitory computer-readable medium described herein may further include operations, features, means, or instructions for aligning transmission of a first portion of the waveform via the one or more sets of frequency resources associated with a first error vector magnitude to a first resource block group boundary and transmission of a second portion of the waveform via one or more additional associated with a second error vector magnitude to a second resource block group boundary, where transmitting the waveform may be based on the aligning.

A method for wireless communications is described. The method may include receiving, from a first wireless device by a second wireless device, control signaling including an indication of a noise shaping scheme, receiving a shaped waveform from the first wireless device by the second wireless device via a frequency band, and decoding, based on the indication of the noise shaping scheme, the shaped waveform according to the noise shaping scheme that shapes distortion associated with crest factor reduction into one or more sets of frequency resources s of the frequency band based on a channel estimate corresponding to the frequency band.

An apparatus for wireless communications is described. The apparatus may include a processor, memory coupled with the processor, and instructions stored in the memory. The instructions may be executable by the processor to cause the apparatus to receive, from a first wireless device by a second wireless device, control signaling including an indication of a noise shaping scheme, receive a shaped waveform from the first wireless device by the second wireless device via a frequency band, and decode, based on the indication of the noise shaping scheme, the shaped waveform according to the noise shaping scheme that shapes distortion associated with crest factor reduction into one or more sets of frequency resources s of the frequency band based on a channel estimate corresponding to the frequency band.

Another apparatus for wireless communications is described. The apparatus may include means for receiving, from a first wireless device by a second wireless device, control signaling including an indication of a noise shaping scheme, means for receiving a shaped waveform from the first wireless device by the second wireless device via a frequency band, and means for decoding, based on the indication of the noise shaping scheme, the shaped waveform according to the noise shaping scheme that shapes distortion associated with crest factor reduction into one or more sets of frequency resources s of the frequency band based on a channel estimate corresponding to the frequency band.

A non-transitory computer-readable medium storing code for wireless communications is described. The code may include instructions executable by a processor to receive, from a first wireless device by a second wireless device, control signaling including an indication of a noise shaping scheme, receive a shaped waveform from the first wireless device by the second wireless device via a frequency band, and decode, based on the indication of the noise shaping scheme, the shaped waveform according to the noise shaping scheme that shapes distortion associated with crest factor reduction into one or more sets of frequency resources s of the frequency band based on a channel estimate corresponding to the frequency band.

In some examples of the method, apparatuses, and non-transitory computer-readable medium described herein, receiving the control signaling may include operations, features, means, or instructions for receiving one or more parameters associated with the noise shaping scheme, the one or more parameters including an indication of a shaping filter, an indication of the one or more sets of frequency resources of the frequency band, a peak to average power ratio target, a number of iterations associated with the noise shaping scheme, a transmission power per symbol, or any combination thereof.

In some examples of the method, apparatuses, and non-transitory computer-readable medium described herein, receiving the control signaling may include operations, features, means, or instructions for receiving a one-bit indication indicating that distortion filtering according to the noise shaping scheme may be enabled.

Some examples of the method, apparatuses, and non-transitory computer-readable medium described herein may further include operations, features, means, or instructions for transmitting, to the first wireless device, an indication of a target error vector magnitude for each of a set of multiple sets of frequency resources including the one or more sets of frequency resources of the frequency band, where decoding the shaped waveform according to the noise shaping scheme may be based on the indication of the target error vector magnitude for each of the set of multiple sets of frequency resources.

In some examples of the method, apparatuses, and non-transitory computer-readable medium described herein, distortion associated with the frequency band may be shaped to the one or more sets of frequency resources based on a channel quality corresponding to the channel estimate.

Some examples of the method, apparatuses, and non-transitory computer-readable medium described herein may further include operations, features, means, or instructions for receiving multiplexed transmissions via a first channel and a second channel, where the distortion may be shaped to at least a portion of the one or more sets of frequency resources overlapping with the first channel according to a threshold error vector magnitude associated with the first channel, and the distortion may be shaped to at least a portion of the one or more sets of frequency resources overlapping with the second channel according to a second threshold error vector magnitude associated with the second channel.

In some examples of the method, apparatuses, and non-transitory computer-readable medium described herein, receiving the shaped waveform may include operations, features, means, or instructions for receiving the shaped waveform according to a first modulation and coding scheme and a first error vector magnitude associated with a first set of one or more user equipments (UEs) including the second wireless device.

Some examples of the method, apparatuses, and non-transitory computer-readable medium described herein may further include operations, features, means, or instructions for transmitting, to the first wireless device, control signaling including an indication of the one or more sets of frequency resources, a first modulation and coding scheme and a second modulation and coding scheme, and a first error vector magnitude and a second error vector magnitude, where the first wireless device includes a UE and the second wireless device includes a network entity.

In some examples of the method, apparatuses, and non-transitory computer-readable medium described herein, receiving the shaped waveform may include operations, features, means, or instructions for receiving a first portion of the shaped waveform according to the first modulation and coding scheme and the first error vector magnitude and receiving a second portion of the shaped waveform according to the second modulation and coding scheme and the second error vector magnitude.

Some examples of the method, apparatuses, and non-transitory computer-readable medium described herein may further include operations, features, means, or instructions for aligning reception of a first portion of the shaped waveform via the one or more sets of frequency resources associated with a first error vector magnitude to a first resource block group boundary and reception of a second portion of the shaped waveform via one or more additional sets of frequency resources associated with a second error vector magnitude to a second resource block group boundary, where receiving the shaped waveform may be based on the aligning.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

FIG. 1 illustrates an example of a wireless communications system that supports channel oriented noise shaping in accordance with one or more aspects of the present disclosure.

FIG. 2 illustrates an example of a wireless communications system that supports channel oriented noise shaping in accordance with one or more aspects of the present disclosure.

FIG. 3 illustrates an example of a noise distribution scheme that supports channel oriented noise shaping in accordance with one or more aspects of the present disclosure.

FIG. 4 illustrates an example of a noise shaping procedure that supports channel oriented noise shaping in accordance with one or more aspects of the present disclosure.

FIG. 5 illustrates an example of a noise shaping scheme that supports channel oriented noise shaping in accordance with one or more aspects of the present disclosure.

FIG. 6 illustrates an example of a process flow that supports channel oriented noise shaping in accordance with one or more aspects of the present disclosure.

FIGS. 7 and 8 illustrate block diagrams of devices that support channel oriented noise shaping in accordance with one or more aspects of the present disclosure.

FIG. 9 illustrates a block diagram of a communications manager that supports channel oriented noise shaping in accordance with one or more aspects of the present disclosure.

FIG. 10 illustrates a diagram of a system including a device that supports channel oriented noise shaping in accordance with one or more aspects of the present disclosure.

FIGS. 11 and 12 illustrate block diagrams of devices that support channel oriented noise shaping in accordance with one or more aspects of the present disclosure.

FIG. 13 illustrates a block diagram of a communications manager that supports channel oriented noise shaping in accordance with one or more aspects of the present disclosure.

FIG. 14 illustrates a diagram of a system including a device that supports channel oriented noise shaping in accordance with one or more aspects of the present disclosure.

FIGS. 15 through 18 illustrate flowcharts showing methods that support channel oriented noise shaping in accordance with one or more aspects of the present disclosure.

### DETAILED DESCRIPTION

In some wireless communications systems, a transmitting device (e.g., a network entity or a user equipment (UE)) may communicate with a receiving device (e.g., a network entity or a UE). However, the transmitting device may generate noise across a channel. For example, to reduce peak to average power ratio (PAPR), a transmitting device may perform some kind of filtering (e.g., iterative clipping and filtering) to avoid or reduce distortion without overly relying on power backoff. However, such filtering may result in noise (e.g., distortion associated with crest factor reduction (CFR)) that causes an error vector magnitude impact (e.g., reduction). The resulting noise may apply consistently across the whole channel or set of channels (e.g., a frequency band). However, link performance between the transmitting device and the receiving device may be based on a signal to noise ratio (SNR), and not an EVM. SNR may change per subset of frequency resources (e.g., may not be consistent across a channel, set of channels, or set of subbands). PAPR reduction with uniform clipping noise may not be efficient (e.g., such clipping noise may have a negative impact to all subbands of a frequency band, despite the fact that some subbands have higher SNR than others). This may result in unnecessary channel quality reduction across a full frequency band.

Techniques described herein may consider frequency domain quality to shape frequency domain noise (e.g., iterative clipping and filtering (ICF) related clipping noise) to locations in which the SNR is bad (e.g., where the channel quality is poor). For example, for one or more subbands on which SNR is low, the transmitting device may be sending a transmission according to a low modulation and coding scheme (MCS), as additional channel noise shaped to such subbands may not have a large impact on transmission quality via such subbands. Thus, by shaping channel noise to one or more subbands with poor SNR (e.g., instead of uniformly distributing such channel noise), the transmission may be more reliable across a frequency band, and quality on other subbands may be improved (e.g., without negatively impacting the quality of communications via subbands that already have a low SNR).

The transmitting device may transmit an indication of a noise shaping scheme to the receiving device to support decoding. In some examples, such an indication may include an indication of MCS for the various subbands, an indication of which subbands the noise is to be shaped to, target EVM, or other parameters. In some examples, such an indication may include a simple (e.g., one-bit) indication that noise shaping schemes are enabled. In some examples, the receiving device may transmit an indication of suggested subbands to which to shape the noise, proposed target EVMs, etc., and the transmitting device may implement the noise shaping based thereon.

Aspects of the disclosure are initially described in the context of wireless communications systems. Aspects of the disclosure are further illustrated by and described with reference to wireless communications systems, noise distribution schemes, noise shaping procedures, noise shaping schemes, and process flows. Aspects of the disclosure are further illustrated by and described with reference to apparatus diagrams, system diagrams, and flowcharts that relate to channel oriented noise shaping.

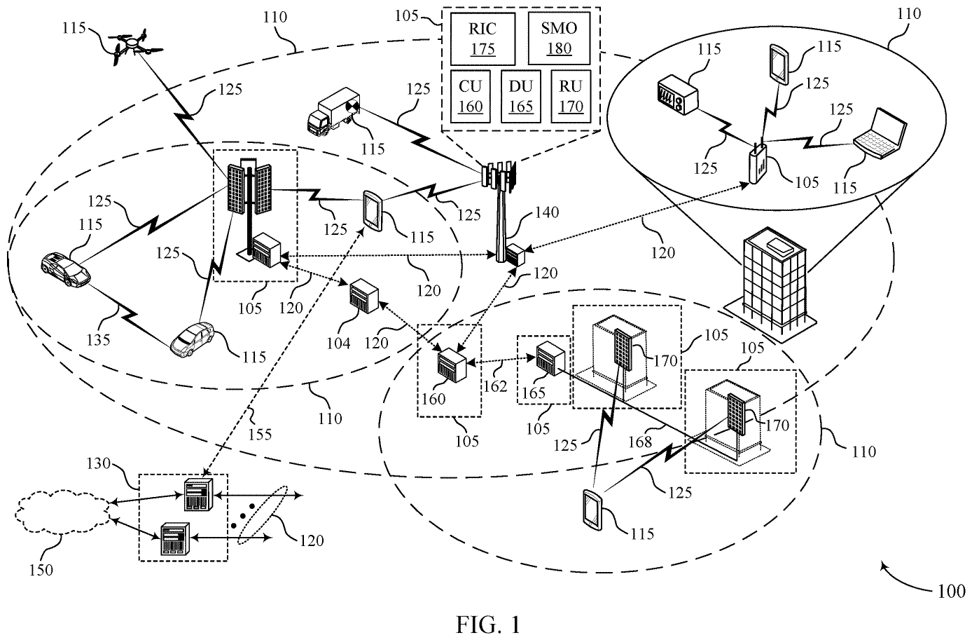

FIG. 1 illustrates an example of a wireless communications system 100 that supports channel oriented noise shaping in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, anode of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support channel oriented noise shaping as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of TS=1/(Δfₘₐₓ−N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A transmitting device (e.g., a UE 115, a network entity 105, among other examples) may determine channel quality (e.g., based on a channel estimate), and may shape frequency domain noise (e.g., ICF related clipping noise) to locations in which the SNR is bad (e.g., where the channel quality is poor) based on the channel quality. For example, for one or more subbands on which SNR is low, the transmitting device may be sending a transmission according to a low modulation and coding scheme (MCS), as additional channel noise shaped to such subbands may not have a large impact on transmission quality via such subbands. Thus, by shaping channel noise to subbands with poor SNR (e.g., instead of uniformly distributing such channel noise), the transmission in other subbands may be more reliable, and quality on other subbands may be improved (e.g., without negatively impacting the quality of communications via subbands that already have a low SNR). By implementing techniques described herein, a transmitting device may operate a channel-aware ICF PAPR reduction block. The PAPR reduction may be extended such that distortion due to digital non-linear transmission operations (e.g., ICF procedures) may be nonuniformly distributed such that more distortion is steered to tones that do not rely on much EVM (e.g., due to limited thermal SNR), and less distortion would be on the tones which experience good channel conditions, and hence higher thermal SNR.

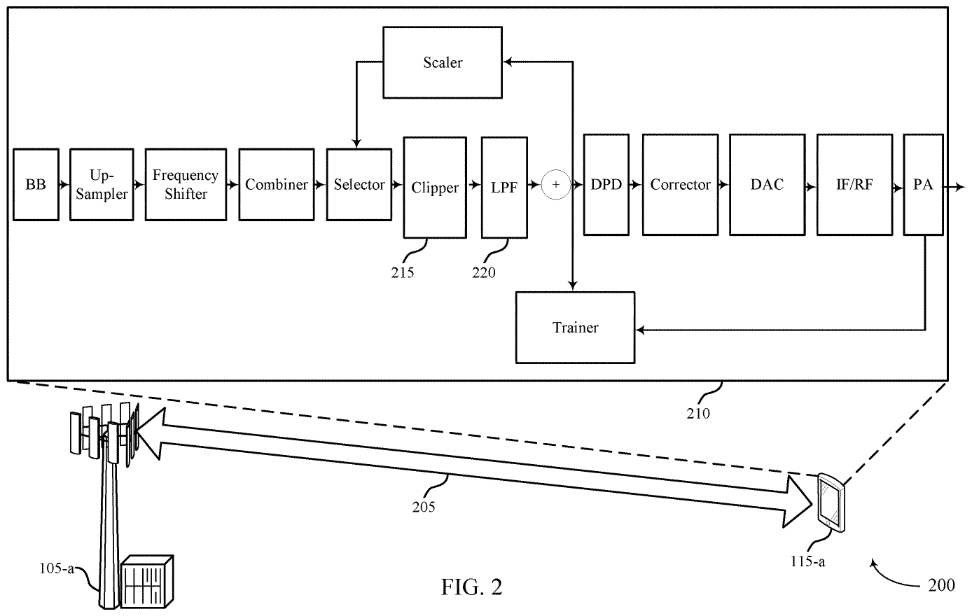

FIG. 2 illustrates an example of a wireless communications system 200 that supports channel oriented noise shaping in accordance with one or more aspects of the present disclosure. Wireless communications system 200 may include a network entity 105-a and a UE 115-a, which may communicate with each other via bidirectional communication link 205. In some examples, the UE 115-a may be a transmitting device, and the network entity 105-a may be a receiving device. However, techniques described herein may be implanted by any transmitting device (e.g., a UE 115-a, a network entity 105-a, a wireless node, an IAB node, among other examples).

Utilization of efficiency of an influential resource, such as radiated power, may impact communications via the wireless communications system 200. The transmitting device (e.g., the UE 115-a) may include one or more non=-linear components, such as a high-power amplifiers (e.g., power amplifiers (PAs)) with limited linear dynamic range. Use of such PAs may result in distortions of a transmitted signal due to high PAPR. Non-linear distortions may be classified as in-band distortions (e.g., which affect link performance such as mutual information and EVM), and out-of-band (OOB) distortion (e.g., which may be limited by regulatory constraints). To avoid distortions, a transmitting device may implement power back-off. However, power back-off may be associated with a cost: higher power back-off may result in less power efficiency (e.g., resulting in less power being transmitted to or via a medium). Alternatively, or additionally, a digital pre-distorter (DPD) coupled with a PAPR reduction block in the digital front end (DFE) of the transmitting device may be used. Such procedures may maintain distortion at a target (e.g., threshold) level, while power back-off is reduced as low as possible, resulting in PA efficiency without overly reducing power.

In some examples, the transmitting device (e.g., the UE 115-a) may perform a procedure 210, which may be a PAPR reduction method including ICF. ICF may be performed by a transmitting device as part of the DFE of the transmitting device. For example, a DFE input (e.g., a baseband (BB) signal) may be input to an up-sampler, and a frequency shifter may shift the frequency of one or more up-samples. The combiner may perform component carrier combinations, and the selector may select a waveform for clipping. The clipper 215 may clip the selected waveform to a PAPR target. The low-pass filter (LPF) 220 may filter the clipped waveform across the bandwidth of the main signal (e.g., may be equal to the bandwidth of the main signal). The clipping and filtering may be done iteratively (e.g. three iterations), where each iteration adds more and more clipping noise to the in band where the desired or targeted signal exists (e.g., across the full bandwidth of the signal). For example, the initially clipped and filtered waveform may be passed through the scaler and the selector, then reclipped and prefiltered multiple times, where each iteration adds to a resulting clipping noise spread across the full frequency range of the waveform.

The transmitting device may perform digital pre-distortion on the clipped and filtered waveform, and the corrector may perform some correction (e.g., transmitter FDR subband and droop correction), and the result may be passed through a digital to analog converter (DAC), an intermediate frequency (IF) radio frequency (RF) component, and a PA, generating a waveform for transmission. The output may be provided to a trainer. In some examples (e.g., via DPD training tap-off), the output of the ICF may also be provided to the trainer (e.g., for DPD training).

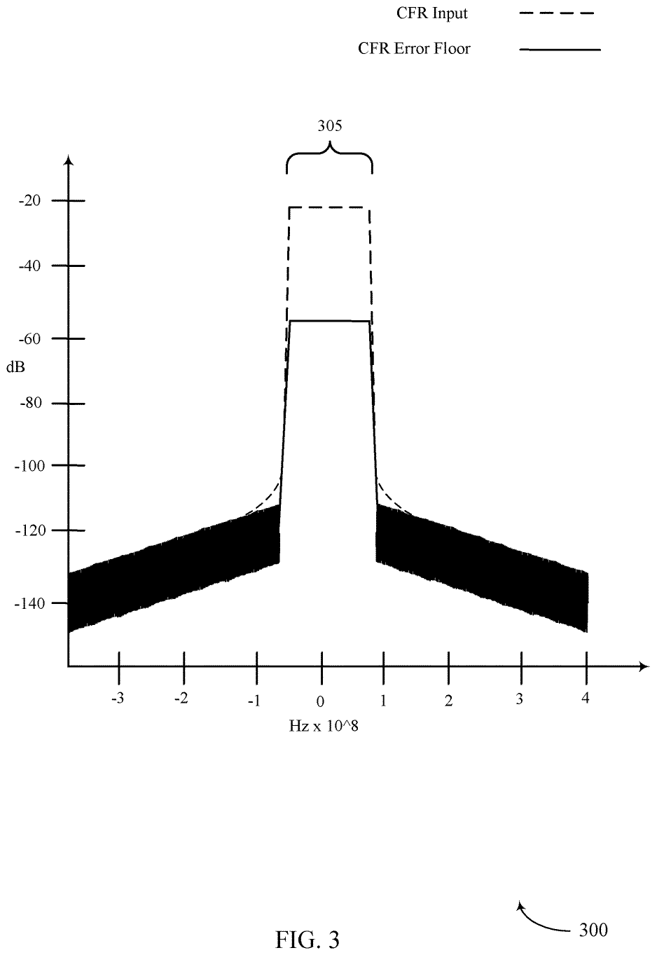

As described in greater detail with reference to FIG. 3, in band noise (e.g., caused by the ICF) may cause an EVM impact (e.g., increase of EVM). Such EVM impacts may be fixed by the receiving device. However, addressing such EVM impacts by the receiving device may rely on advanced signal processing, and some receiving devices may not be equipped for such advanced signal processing. Additionally, or alternatively, advanced signal processing for devices equipped to perform such signal processing may result in increased power expenditures, and increased delays, resulting in increased system delays and system latency.

In some examples, as described herein, a transmitting device (e.g., a UE 115-a, a network entity 105-a, among other examples) may perform channel oriented noise shaping based on channel quality of specific frequency ranges. The transmitting device may determine channel quality (e.g., based on a channel estimate), and may shape frequency domain noise (e.g., ICF related clipping noise) to one or more subbands in which the SNR is bad (e.g., where the channel quality is poor) based on the channel quality. For example, for one or more subbands on which SNR is low, the transmitting device may be sending a transmission according to a low modulation and coding scheme (MCS), as additional channel noise shaped to such subbands may not have a large impact on transmission quality via such subbands. Thus, by shaping channel noise to subbands with poor SNR (e.g., instead of uniformly distributing such channel noise), the transmission in other subbands may be more reliable (e.g., subbands that have improved SNR), and quality on other subbands may be improved (e.g., without negatively impacting the quality of communications via subbands that already have a low SNR).

FIG. 3 illustrates an example of a noise distribution scheme 300 that supports channel oriented noise shaping in accordance with one or more aspects of the present disclosure. A transmitting device may generate a waveform according to the noise distribution scheme (e.g., as described with reference to FIG. 2).

The transmitting device may perform a procedure, such as an ICF approach, in which noise (e.g., clipping noise) is distributed (e.g., mostly) uniformly in an in-band scenario, and controlled according to a PAPR target parameter, which may dictate a tradeoff between clipping noise and PAPR. For instance, an input crest factor reduction (CFR) input for a range of frequency resources (e.g., a frequency band 305) may be associated with an infinite EVM. For a PAPR reduction target of 9 dB, the transmitting device may experience an associated cost in EVM of about 40 dB (e.g., as illustrated by the CFR error floor at about −60 dB). Similarly (e.g., although not illustrated), for a PAPR target of 6 dB, PAPR may be reduced by about 3 dB more (e.g., which is transmitted to a corresponding back-off at a PA). Such a PAPR target may result in an EVM cost of about 24 dB. The EVM cost may be paid across the entire band 305. For example, EVM may be reduced for transmissions across a full range of frequency resources (e.g., band 305) regardless of individual channel quality of subsets of frequency resources of the band 305 (e.g., subbands). Such an approach may support system simplicity. That is, by controlling a single parameter (e.g., a PAPR target), out-of-band emissions are maintained to support regulations or constraints (e.g., the transmission occurs within the band 305), and the result is a back-off optimization. However, such an approach considers only the EVM cost, and does not make use of channel quality information (e.g., SNR) for subbands or subsets of frequency resources within the channel 305. SNR may be more relevant to link performance. Thus, the EVM cost across the full band 305 may result in decreased link quality for the UE on at least some channels.

For example, link quality (e.g., not EVM) may dictate link performance. Because channels are frequency selective, SNR may change per tone. Thus, using a PAPR reduction based on uniform noise distribution (e.g., uniform clipping noise) may not be efficient in maintaining per-tone channel quality.

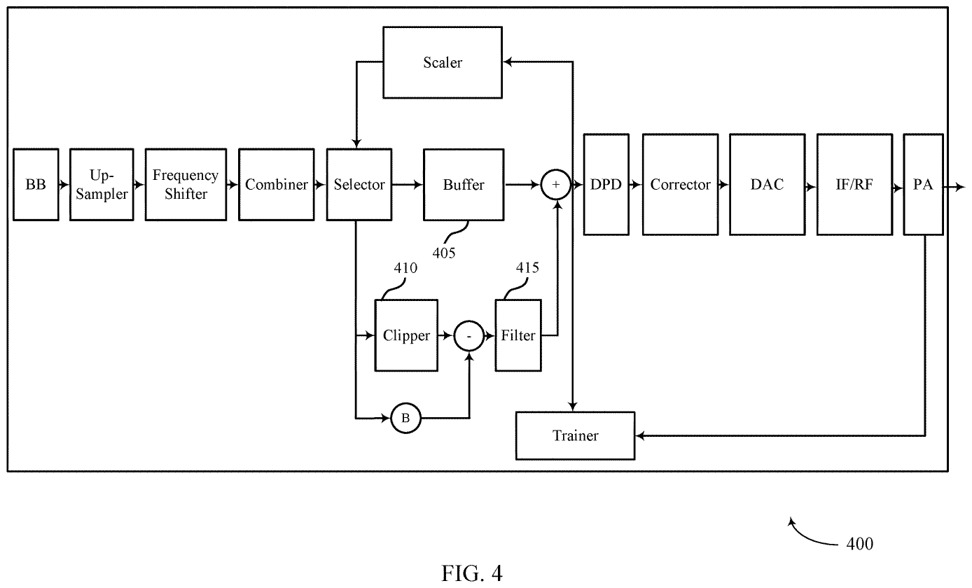

As described herein, a transmitting device may shape noise (e.g., clipping noise) to channels with low quality and corresponding lower MCSs. The transmitting device may obtain channel quality through one or more procedures. For example, for downlink signaling (e.g., the transmitting device is a network entity 105), the transmitting device may obtain channel quality via reporting (e.g., channel quality information (CQI), rank indicator (RI), or the like) from a receiving device (e.g., a UE 115). For uplink signaling (e.g., the transmitting device is a UE 115), the transmitting device may obtain channel quality via channel quality estimations (e.g., based on reference signals such as sounding reference signals (SRSs) received and measured by the UE from the network entity). The transmitting device may determine that a frequency response of a channel is varied across tones. For example, SNR may not be uniform across a channel, or across a band 305. Thus, as described in greater detail with reference to FIGS. 4-6, a transmitting device may shape noise to low-quality frequency resources, resulting in improved channel quality on other tones and increased signaling reliability.

FIG. 4 illustrates an example of a noise shaping procedure 400 that supports channel oriented noise shaping in accordance with one or more aspects of the present disclosure. The noise shaping procedure may be performed by a transmitting device (e.g., such as a UE 115 or a network entity 105), which may be an example of corresponding devices described with reference to FIGS. 1-3. The transmitting device may include one or more components, and may perform DFE procedures similar to the procedure 210 described with reference to FIG. 2.

As described with reference to FIGS. 2-3, a channel may not be uniform (e.g., SNR may vary across tones of a channel or frequency band). Because of the non-uniform SNR, it may not be efficient for the PAPR reduction to be paid for uniformly in the frequency domain. Instead, techniques described herein include determining frequency domain quality across a frequency band (e.g., due to linear channel and thermal noise) and shape the frequency domain noise (e.g., the IDC related clipping noise) to locations in which SNR is bad (e.g., due to poor channel quality).

For example, the transmitting device may perform clipping (e.g., hard or soft clipping) using the clipper 410. The clipping may result in noise (e.g., ICF related clipping noise). The transmitting device may remove the waveform after performing the clipping, and may perform filtering on the remaining noise. The shaping filter 415 may be responsible for shaping the distortion (e.g., shaping the noise), and the filter applied may be defined by channel quality (e.g., as estimated by or reported to the transmitting device). For example, if channel quality is poor on a first subset of frequency resources (e.g., a first set of tones, or a first set of subbands), and channel quality is good (e.g., above a threshold) on a second subset of frequency resources (e.g., a second set of tones, or a second set of subbands), the filter 415 may shape the noise to the first subset of frequency resources (e.g., instead of uniformly distributing the noise across the full set of frequency resources such as a full frequency band). The transmitting device may also apply (e.g., multiple by) a Bussgang coefficient B. The Bussgang coefficient may be a weighted set of one or more values applied to the noise for the shaping filter.

The transmitting device may also use a buffer 405 (e.g., a delay buffer) which may be used to delay until the shaping filter has been applied (e.g., a shaping filter group delay). Upon completing the filter, the transmitting device may add the noise back to the waveform (e.g., according to the shaping performed by the filter 415) and continue processing as part of the DFE processing. Such techniques may result in improved reliability of signaling, and reduced channel noise on at least some frequency resources of a frequency band, as described in greater detail with reference to FIG. 4.

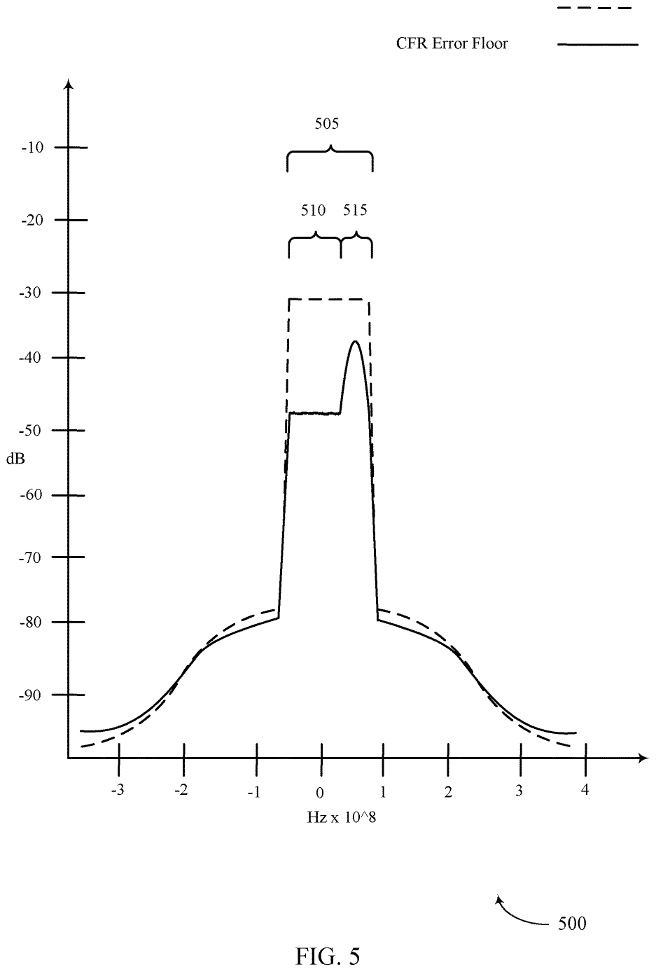

FIG. 5 illustrates an example of a noise shaping scheme 500 that supports channel oriented noise shaping in accordance with one or more aspects of the present disclosure. The noise distribution scheme 500 may be performed by a transmitting device (e.g., such as a UE 115 or a network entity 105), which may be an example of corresponding devices described with reference to FIGS. 1-4. The transmitting device may include one or more components, and may perform DFE procedures similar to the noise shaping procedure 400 described with reference to FIG. 4.

The transmitting device may determine channel quality for a range of frequency resources (e.g., a band 505). The transmitting device may determine channel quality for the frequency resources of the frequency band 505. If the transmitting device is a network entity, the transmitting device may receive a channel estimate from the receiving device (e.g., a UE). If the transmitting device is a UE, then the transmitting device may perform a channel estimate (e.g., based on received reference signals from a network entity). The transmitting device may determine an SNR for the frequency resources of the frequency band based on the channel estimate. The transmitting device may determine, based on the channel estimate, that a channel quality in a first set of frequency resources 510 (e.g., a first set of tones, subbands, channels, etc.) is good (e.g., satisfies or is above a threshold), while the channel quality in a second set of frequency resources 515 (e.g., a second set of tones, subbands, channels, etc.) is bad (e.g., does not satisfy or is below a threshold). In such examples, the transmitting device may transmit signaling via the first set of frequency resources 510 using a higher MCS, and may transmit signaling via the second set of frequency resources 515 using a lower MCS. Because of the selected MCSs, an increase in noise (e.g., and a larger EVM) across the second set of frequency resources 510 may not have a negative impact on the transmissions via the second set of frequency resources 510. However, noise distributed across the first set of frequency resources 515 may result in a decrease in channel quality, a lower MCS value, a higher EVM value etc. Instead, according to techniques described herein, the transmitting device may shape noise to the second set of frequency resources 510 (e.g., resulting in a larger EVM), and away from the first set of frequency resources 515. For example, one or more procedures (e.g., a ICF procedure as described with reference to FIG. 2) may result in the introduction or addition of noise (e.g., the source of the distortion may be CFR). Such shaping of the noise may allow the transmitting device to transmit wireless signaling via the first set of frequency resources 515 at a higher MCS (e.g., instead of having to reduce the MCS to accommodate uniformly distributed noise). Thus, the transmitting device may transmit wireless signaling via the first set of frequency resources 510 according to a first (e.g., higher) MCS and a first EVM, and may transmit wireless signaling via the second set of frequency resources 515 according to a second (e.g., lower) MCS and a second EVM. In some examples, the difference between the first EVM and the second EVM may be due to non-uniform shaping of the CFR noise.

For example, the transmitting device may calculate SNR (e.g., end-to-end SNR), and may include one or more PAs (e.g., according to a RAPP model, with a sharpness of 1.6). The band 505 may represent, in an illustrative example, a component carrier with a 100 MHz bandwidth. If the transmitting device merely performs back-off procedures (e.g., using a PA back-off of 7.7 dB), the average SNR at the receiving device may be about 33.5 dB (e.g., due to the uniform clipping noise caused by the ICF). If the transmitting device also performs additional procedures to address PAPR, the uniform distortion may be applied, resulting in an EVM of about 23 dB based on a PA back-off of about 6.2 dB.

However, by implementing the described techniques (e.g., non-uniform ICF distortion) where the ICF distortion is shaped such that a filter is used to steer the ICF distortion to a limited set of tones on which the channel is poor (e.g., the second set of frequency resources 515), the steered ICF distortion may not have any practical effect on performance (e.g., because SNR of the second set of frequency resources 515 may be dominated by thermal noise in any case). In an illustrative example, the transmitting device may achieve about 35 dB of SNR (e.g., more than 9 dB of SNR better than the simple back-off approach of about 33.5 dB using similar parameters) on the tones with good SNR (e.g., the first set of frequency resources 510). Wireless signaling via the tones of the bad channels (e.g., the second set of frequency resources 515) may achieve an SNR that is about 15 dB (e.g., but 15 dB EVM for the second set of frequency resources may be sufficient, for the MCS used by the transmitting device for the low SNR of the first set of frequency resources). The transmitting device may shape the noise as described herein, while still satisfying an OOB constraint, and gaining on a link budget (e.g., about 1.5 dB of the link budget and power consumption gain).

By performing techniques described herein, the transmitting device may sacrifice (e.g., pay a cost) of EVM on some tones (e.g., the second set of frequency resources 515, on which the channel conditions are poor, and SNR will be low in any case), and may improve the EVM on other tones (e.g., the first set of frequency resources 510, on which the channel conditions are good and would suffer from additional noise). For example, because tones with a poor EVM due to the techniques described herein already experience thermal noise as a dominant form of distortion, EVM resulting from the techniques described herein may not significantly impact or degrade performance on those tones (e.g., the second set of frequency resources 515). Such techniques may result in back-off improvements (e.g., a benefit of about 1.4 dB), and such savings may be translated to link budget improvements, power consumption savings, or the like. In some examples, the second set of frequency resources 515 may be any quantity of tones in the frequency band 505 (e.g., a small percentage, an even split, a large percentage). For instance, the second set of frequency resources 515 on which the SNR is poor may make up twenty-five percent of the frequency band 505 (e.g., in which case twenty-five percent of the tones of the frequency band 505 may be sacrificed as noise may be steered to the second set of frequency resources 515), or may make up fifty percent of the frequency band 505 (e.g., in which case fifty percent of the tones of the frequency band 505 may be sacrificed as noise may be steered to the second set of frequency resources 515). In any case, such sacrifices may not significantly impact the quality of signaling via the second set of frequency resources 515 (e.g., which already experience low SNR), but may significantly improve the quality of signaling via the first set of frequency resources 510 (e.g., because the channel noise is steered away from the first set of frequency resources 510).

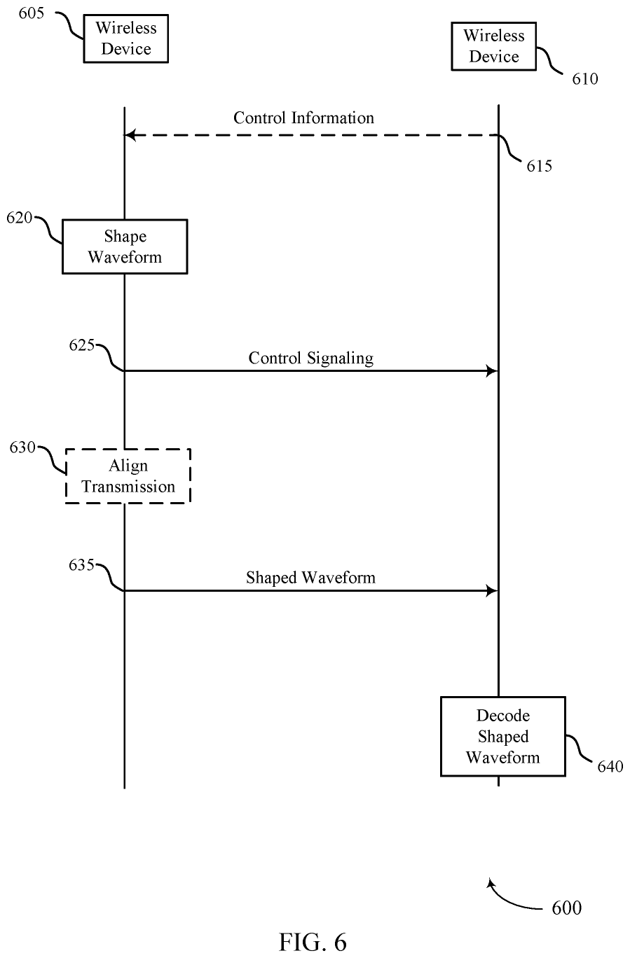

In some examples, the transmitting device may provide some parameters for the receiving device to decode the transmission, as described in greater detail with reference to FIG. 6.

FIG. 6 illustrates an example of a process flow 600 that supports channel oriented noise shaping in accordance with one or more aspects of the present disclosure. The process flow 600 may include a wireless device 605 (e.g., a UE 115 or a network entity 105), and a wireless device 610 (e.g., a UE 115 or a network entity 105), which may be examples of corresponding devices described with reference to FIGS. 1-5.

At 620, the wireless device 605 may shape a waveform to generate a shaped waveform for transmission by the wireless device 605 at 635. The wireless device 605 may shape the waveform according to a noise shaping scheme to shape distortion (e.g., noise) associated with CFR into one or more sets of frequency resources (e.g., one or more tones, one or more subbands, one or more channels, among other examples) of a frequency band (e.g., or any range of frequency resources) based on a channel estimate (e.g., estimated by the wireless device 605 if the wireless device 605 is a UE 115, or reported to the wireless device 605 if the wireless device 605 is a network entity 105) corresponding to the frequency band. The wireless device 605 may perform the shaping of the waveform according to techniques described herein (e.g., with reference to FIGS. 4-5). In some examples, the wireless device 605 may shape ICF related noise (e.g., a PAPR method associated with distortion). However, noise may be introduced as part of any PAPR reduction procedure. In any such case, the wireless device 605 may shape the noise to sets of frequency resources that have low SNR.

In some examples (e.g., for a downlink transmission where the wireless device 605 is a network entity), the wireless device 605 may shape the waveform based on the location of different channels. For example, the transmitting device may multiplex transmissions via a first channel and a second channel, where shaping the waveform at 620 incudes shaping the distortion to at least a portion of the one or more sets of frequency resources overlapping with the first channel according to a threshold EVM associated with the first channel. For instance, a physical downlink control channel (PDCCH) and a physical downlink shared channel (PDSCH) may be frequency division multiplexed (FDM), and the wireless device 605 may shape the filter to a higher EVM in one or more frequency resources (e.g., REs, RBs, subbands, or the like) of the PDCCH. In some examples, one or more rules (e.g., indicated via control signaling, or defined in one or more standards) may indicate that different EVMs may be associated with different channels on the same symbol. For example, the wireless device 605 may transmit, at 635, the waveform according to a first EVM (e.g., via the resources of one channel to which the noise is shaped) and according to a second EVM (e.g., via the resources of another channel from which the noise is shaped away). In some examples, the rules may define which channel is prioritized (e.g., for any two channels, the wireless device 605 may shape the noise to one of the two channels based on prioritization rules, and may transmit according to different EVMs for the different channels according to the prioritization rules).

Similarly, if the wireless device 605 is a UE performing uplink transmissions, the UE may shape the filter to a higher EVM for a UCI, when a UCI is transmitted over a PUSCH (e.g., if the wireless device 605 multiplexes (e.g., frequency division multiplexes) a UCI on a PUSCH, the UCI may be the region with the higher EVM according to the shaping scheme).

At 625, the wireless device 605 may transmit, to the wireless device 610, control signaling including an indication of the noise shaping scheme. Such control signaling may support the receiving wireless device 610 (e.g., the equalizer of the wireless device 610 may benefit from information regarding the shaping scheme (e.g., the ICF distortion spectrum)).

In an example, the receiving device, as a part of noise whitening matrix estimation by an equalizer of the receiving device, may perform less narrow frequency domain filtering if an ICF distortion spectrum is signaled from the transmitter to indicate that the transmitter is using spectral shaping, to beneficially enable the receiver to perform wide distortion matrix estimation. In some examples, the wireless device 605 may include, in the control signaling (e.g., layer 1 (L1) or layer 2 (L2), a one-bit indication which may indicate whether the wireless device 605 has used non-uniform noise distribution (e.g., channel aware ICF distortion distribution) or uniform noise distribution. In some examples, the wireless device 605 may include, in the control signaling (e.g., L1 or L2 signaling), an indication of the filter used to shape the noise (e.g., the ICF distortion), and one or more additional parameters associated with the shaping scheme (e.g., a PAPR target, a number of iterations of the ICF procedure, among other examples). In some examples, the control signaling may further include a definition of a mixed set of parameters. For instance, the control signaling may include an indication of a first set of parameters (e.g., parameter set A) for a first set of one or more iterations of the shaping scheme (e.g., first 3 iterations use parameter set A) and another set of parameters (e.g., parameter set B) for a second set of one or more iterations of the shaping scheme. Such mixed sets may be applied to, for example, static channels (e.g., a channel such as a backhaul (BH) channel of a repeater), or a dynamic channel where the dynamics are relatively slow (e.g., and the channel is relatively static or stable for periods of time and overhead is limited). In some examples, the wireless device 605 may indicate (e.g., at 625) transmit power (e.g., a signal power boost per symbol, per channel, or both, among other examples).

In some examples (e.g., at 615), the wireless device 605 may receive, from the second wireless device 610, an indication of a target EVM for each set of a sets of frequency resources including the one or more sets of frequency resources of the frequency band. The wireless device 605 may shape the waveform according to the noise shaping scheme based at least in part on the indication of the target EVM for each of the multiple sets of frequency resources. For example, in cases where the frequency band experiences relatively static interference (e.g., from adjacent cells) on certain one or more tones, the wireless device 610 may indicate the suggested (e.g., target) EVM (e.g., or SNR at the receiving wireless device 610) that the transmitting wireless device 605 should use. The target or suggested EVM (e.g., or SNR) may be per each set of one or more resources (e.g., per tone, per RB, per range of frequency, per subband, per channel, or the like). The control signaling may result in some increased signaling overhead, but may be implemented in specific cases (e.g., in which environment and interference statistics remain static, such as a BH channel with a deployed repeater).

At 635, the wireless device 605 may transmit the shaped waveform to the second wireless device via the frequency band based on the noise shaping scheme. In some examples, the wireless device 605 may transmit at least a portion of the waveform to a first set of one or more UEs via the one or more frequency resources according to a first EVM, a first MCS, or both, and may transmit at least a portion of the waveform to a second set of one or more UEs via one or more additional sets of frequency resources of the frequency band according to a second EVM, a second MCS, or both. For example, in the case where the wireless device 605 is a network entity 105, the wireless device 605 may transmit the waveform to several FDMed UEs, according to various EVM thresholds. The wireless device 605 may shape the noise (e.g., the ICF distortion) and steer the distortion from high EVM regions (e.g., from the first set of frequency resources 510 described with reference to FIG. 5) to low EVM regions (e.g., to the second set of frequency resources 515 described with reference to FIG. 5). In such examples, the wireless device 605 may transmit at least a portion of the waveform to the first set of UEs and at least a portion of the waveform to the second set of UEs.

In some examples, some UEs may be associated with high EVM regions (e.g., poor channel quality) and some UEs may be associated with low EVM regions (e.g., high channel quality). In such examples, the network entity may transmit the waveform in the high EVM regions using a first (e.g., low) MCS, and may transmit in the low EVM regions using a second (e.g., high) MCS. In such examples, some tones within the frequency band (e.g., or within a component carrier) are associated with different EVMs, and the network entity may allocate different (e.g., mixed) MCSs for those tones. The network entity may indicate the EVM allocation to the UEs (e.g., along with, or via separate signaling from, the MCSs). For example, the network entity may indicate, via control signaling, different EVM levels for different tones on a same CC (e.g., may indicate a first EVM level for the set of frequency resources 510, and a second EVM level for the set of frequency resources 515). The EVM allocation may be indicated via control signaling, and may be coupled to non-uniform EVM distribution (e.g., may be indicated as part of a shaping scheme). For example, instead of defining the MCS per CC, the network entity may be able to allocate MCS per specific regions in a CC (e.g., specific tones, RBs, REs, channels, subbands, or the like), which may be EVM dependent.

In some examples, the wireless device 605 may receive, from the wireless device 610, control signaling (e.g., at 615) including an indication of the one or more sets of frequency resources, a first MCS corresponding to a first EVM and a second MCS corresponding to a second EVM. The first wireless device 605 may be a UE and the second wireless device comprises a network entity. Or, the first wireless device 605 may be a network entity and the second wireless device 610 may be a UE. For instance, the receiving device (e.g., the network entity) may indicate, to one or more UEs (e.g., the transmitting device), to which frequencies the UE is able to steer the ICF distortion. The network entity may further indicate MCSs changes e.g., mixed MCS) for the indicated frequencies. For instance, the wireless device 605 may receive an indication (e.g., at 615) indicating a set of frequency regions or frequency resources (e.g., tones, REs, RBs, etc.) to which the wireless device 605 is to steer ICF distortion, and MCSs associated with the indicated frequency resources (e.g., a first MCS associated with the first set of frequency resources 510 and a second MCS associated with the second set of frequency resources 515), EVMs associated with the indicated frequency resources (e.g., a first EVM associated with the first set of frequency resources 510 and a second EVM associated with the second set of frequency resources 515), or any combination thereof. The transmitting device 605 may transmit a first portion of the waveform according to the first MCS and may transmit a second portion of the waveform according to the second MCS.

In some examples, at 630, the wireless device 605 may align transmission of the shaped waveform at 635. For example, the wireless device 605 may be a network entity. In such examples, the network entity may align the regions associated with different EVMs to resource block group (RGB) boundaries (e.g., to avoid misalignment in recurrent neural network (Rnn) estimation by the wireless device 610). Similarly, in the case where mixed EVM is signaled (e.g., indicated to or by the wireless device 605), and the EVMs to be associated with different frequency ranges do not fall on RBG boundaries, the receiving device (e.g., the wireless device 610) may align estimation of the whitening matrix of the shaped waveform 635 to the EVM regions (e.g., on top of baseline RBG boundaries).

At 640, the wireless device 610 may decode the shaped waveform received at 635 based at least in part on the indication of the noise shaping scheme (e.g., as indicated via the control signaling at 625).

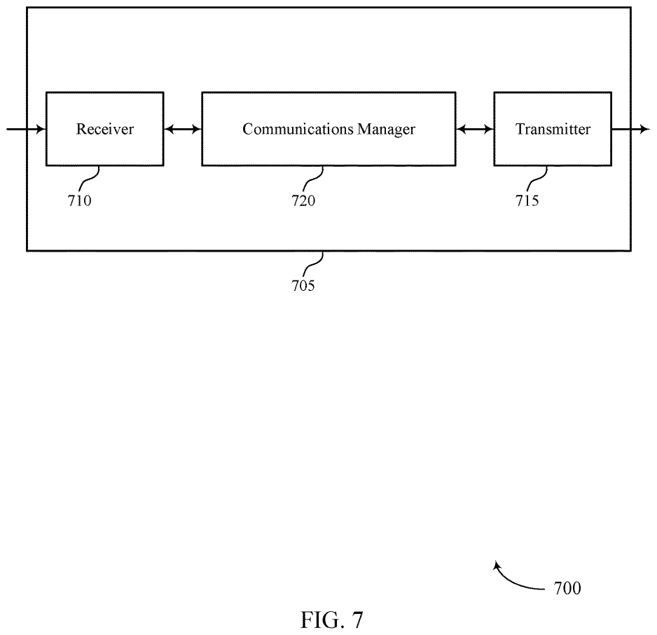

FIG. 7 illustrates a block diagram 700 of a device 705 that supports channel oriented noise shaping in accordance with one or more aspects of the present disclosure. The device 705 may be an example of aspects of a transmitting device as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to channel oriented noise shaping). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to channel oriented noise shaping). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of channel oriented noise shaping as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. For example, the communications manager 720 may be configured as or otherwise support a means for shaping a waveform to generate a shaped waveform for transmission by a first wireless device to a second wireless device according to a noise shaping scheme to shape distortion associated with crest factor reduction into one or more sets of frequency resources of a frequency band based on a channel estimate corresponding to the frequency band. The communications manager 720 may be configured as or otherwise support a means for transmitting, to the second wireless device, control signaling including an indication of the noise shaping scheme. The communications manager 720 may be configured as or otherwise support a means for transmitting the shaped waveform to the second wireless device via the frequency band based on the noise shaping scheme.

By including or configuring the communications manager 720 in accordance with examples as described herein, the device 705 (e.g., a processor controlling or otherwise coupled with the receiver 710, the transmitter 715, the communications manager 720, or a combination thereof) may support techniques for channel-aware noise shaping, resulting in reduced processing, reduced power consumption, improved channel quality, and more efficient utilization of communication resources.

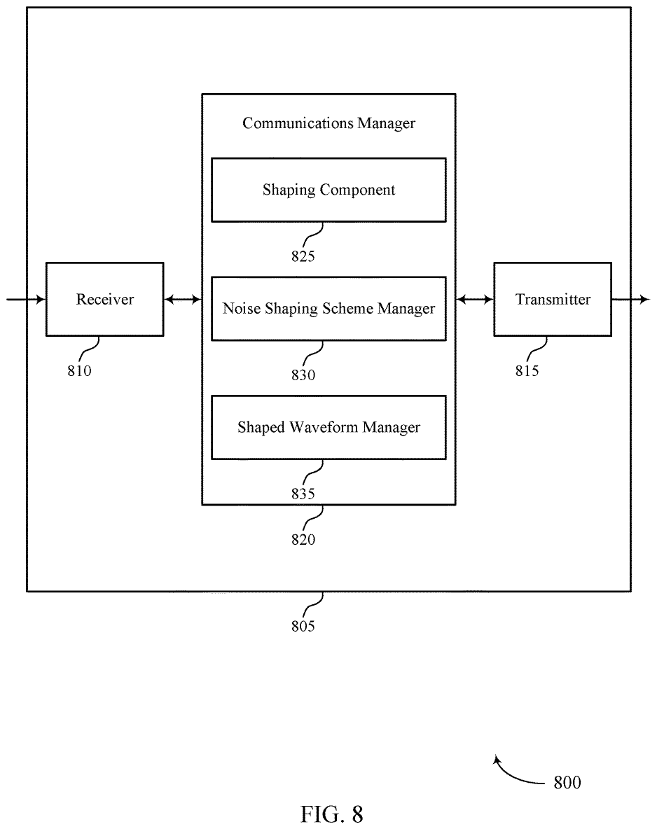

FIG. 8 illustrates a block diagram 800 of a device 805 that supports channel oriented noise shaping in accordance with one or more aspects of the present disclosure. The device 805 may be an example of aspects of a device 705 or a transmitting device 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to channel oriented noise shaping). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to channel oriented noise shaping). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of channel oriented noise shaping as described herein. For example, the communications manager 820 may include a shaping component 825, a noise shaping scheme manager 830, a shaped waveform manager 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. The shaping component 825 may be configured as or otherwise support a means for shaping a waveform to generate a shaped waveform for transmission by a first wireless device to a second wireless device according to a noise shaping scheme to shape distortion associated with crest factor reduction into one or more sets of frequency resources of a frequency band based on a channel estimate corresponding to the frequency band. The noise shaping scheme manager 830 may be configured as or otherwise support a means for transmitting, to the second wireless device, control signaling including an indication of the noise shaping scheme. The shaped waveform manager 835 may be configured as or otherwise support a means for transmitting the shaped waveform to the second wireless device via the frequency band based on the noise shaping scheme.

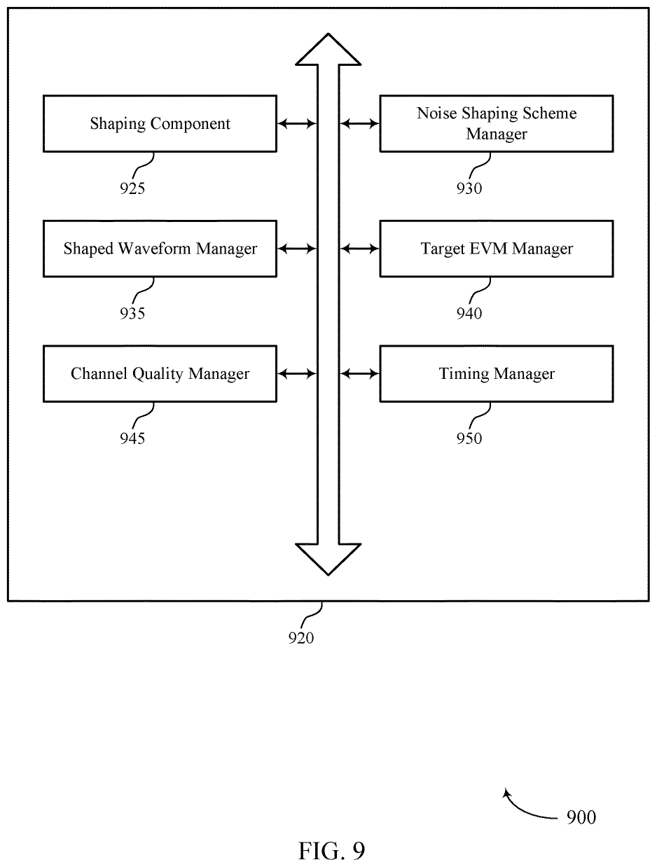

FIG. 9 illustrates a block diagram 900 of a communications manager 920 that supports channel oriented noise shaping in accordance with one or more aspects of the present disclosure. The communications manager 920 may be an example of aspects of a communications manager 720, a communications manager 820, or both, as described herein. The communications manager 920, or various components thereof, may be an example of means for performing various aspects of channel oriented noise shaping as described herein. For example, the communications manager 920 may include a shaping component 925, a noise shaping scheme manager 930, a shaped waveform manager 935, a target EVM manager 940, a channel quality manager 945, a timing manager 950, or any combination thereof. Each of these components may communicate, directly or indirectly, with one another (e.g., via one or more buses).

The communications manager 920 may support wireless communications in accordance with examples as disclosed herein. The shaping component 925 may be configured as or otherwise support a means for shaping a waveform to generate a shaped waveform for transmission by a first wireless device to a second wireless device according to a noise shaping scheme to shape distortion associated with crest factor reduction into one or more sets of frequency resources of a frequency band based on a channel estimate corresponding to the frequency band. The noise shaping scheme manager 930 may be configured as or otherwise support a means for transmitting, to the second wireless device, control signaling including an indication of the noise shaping scheme. The shaped waveform manager 935 may be configured as or otherwise support a means for transmitting the shaped waveform to the second wireless device via the frequency band based on the noise shaping scheme.

In some examples, to support transmitting the control signaling, the noise shaping scheme manager 930 may be configured as or otherwise support a means for transmitting one or more parameters associated with the noise shaping scheme, the one or more parameters including an indication of a shaping filter, an indication of the one or more sets of frequency resources of the frequency band, a peak to average power ratio target, a number of iterations associated with the noise shaping scheme, a transmission power per symbol, or any combination thereof.

In some examples, to support transmitting the control signaling, the noise shaping scheme manager 930 may be configured as or otherwise support a means for transmitting a one-bit indication indicating that distortion filtering according to the noise shaping scheme is enabled.

In some examples, the target EVM manager 940 may be configured as or otherwise support a means for receiving, from the second wireless device, an indication of a target error vector magnitude for each of a set of multiple sets of frequency resources including the one or more sets of frequency resources of the frequency band, where shaping the waveform according to the noise shaping scheme is based on the indication of the target error vector magnitude for each of the set of multiple sets of frequency resources.

In some examples, to support shaping the waveform, the channel quality manager 945 may be configured as or otherwise support a means for identifying, based on the channel estimate, that channel quality corresponding to the one or more sets of frequency resources is lower than channel quality corresponding to one or more additional sets of frequency resources of the frequency band. In some examples, to support shaping the waveform, the shaping component 925 may be configured as or otherwise support a means for shaping distortion associated with the frequency band to the one or more sets of frequency resources based on the identifying according to the noise shaping scheme.

In some examples, the noise shaping scheme manager 930 may be configured as or otherwise support a means for multiplexing transmissions via a first channel and a second channel, where shaping the distortion includes shaping the distortion to at least a portion of the one or more sets of frequency resources overlapping with the first channel according to a threshold error vector magnitude associated with the first channel.

In some examples, to support shaping the distortion, the noise shaping scheme manager 930 may be configured as or otherwise support a means for shaping the distortion to at least a portion of the one or more sets of frequency resources overlapping with the second channel according to a second threshold error vector magnitude associated with the second channel.

In some examples, the first channel includes a physical downlink control channel and the second channel includes a physical downlink shared channel, and the first wireless device includes a network entity.

In some examples, the first channel includes a physical uplink control channel and the second channel includes a physical uplink shared channel, and the first wireless device includes a UE.

In some examples, to support transmitting the waveform, the shaped waveform manager 935 may be configured as or otherwise support a means for transmitting at least a portion of the waveform to a first set of one or more user equipments (UEs) via the one or more sets of frequency resources according to a first error vector magnitude, a first modulation and coding scheme, or both. In some examples, to support transmitting the waveform, the shaped waveform manager 935 may be configured as or otherwise support a means for transmitting at least a portion of the waveform to a second set of one or more UEs via one or more additional sets of frequency resources of the frequency band according to second error vector magnitude, a second modulation and coding scheme, or both.

In some examples, the shaped waveform manager 935 may be configured as or otherwise support a means for receiving, from the second wireless device, control signaling including an indication of the one or more sets of frequency resources, a first modulation and coding scheme corresponding to a first error vector magnitude and a second modulation and coding scheme corresponding to a second error vector magnitude, where the first wireless device includes a UE and the second wireless device includes a network entity.

In some examples, to support transmitting the waveform, the shaped waveform manager 935 may be configured as or otherwise support a means for transmitting a first portion of the waveform according to the first modulation and coding scheme and the first error vector magnitude. In some examples, to support transmitting the waveform the shaped waveform manager 935 may be configured as or otherwise support a means for transmitting a second portion of the waveform according to the second modulation and coding scheme and the second error vector magnitude.

In some examples, the timing manager 950 may be configured as or otherwise support a means for aligning transmission of a first portion of the waveform via the one or more sets of frequency resources associated with a first error vector magnitude to a first resource block group boundary and transmission of a second portion of the waveform via one or more additional associated with a second error vector magnitude to a second resource block group boundary, where transmitting the waveform is based on the aligning.

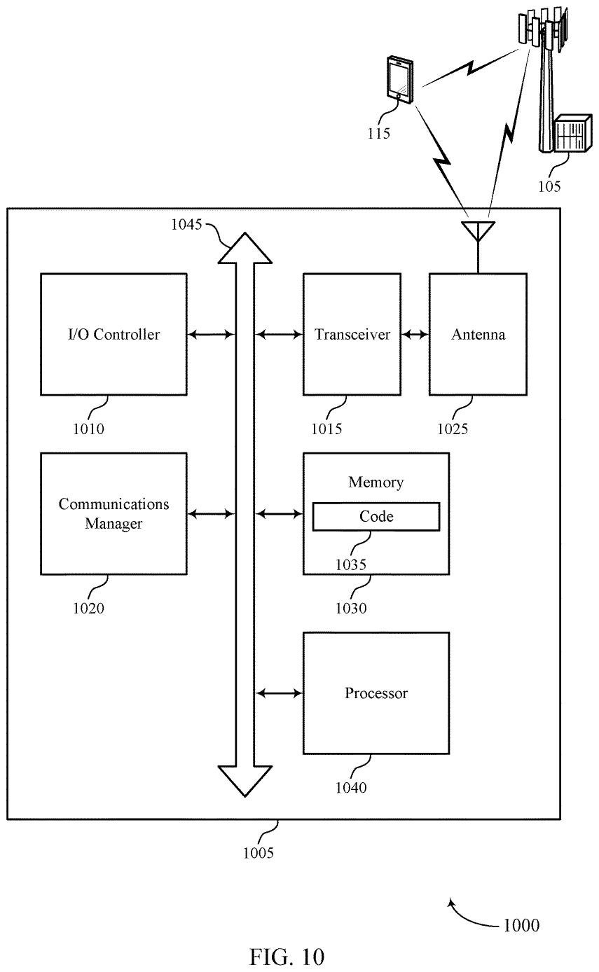

FIG. 10 illustrates a diagram of a system 1000 including a device 1005 that supports channel oriented noise shaping in accordance with one or more aspects of the present disclosure. The device 1005 may be an example of or include the components of a device 705, a device 805, or a transmitting device as described herein. The device 1005 may include components for bi-directional voice and data communications including components for transmitting and receiving communications, such as a communications manager 1020, an I/O controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include RAM and ROM. The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a BIOS which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting channel oriented noise shaping). For example, the device 1005 or a component of the device 1005 may include a processor 1040 and memory 1030 coupled with or to the processor 1040, the processor 1040 and memory 1030 configured to perform various functions described herein.

The communications manager 1020 may support wireless communications in accordance with examples as disclosed herein. For example, the communications manager 1020 may be configured as or otherwise support a means for shaping a waveform to generate a shaped waveform for transmission by a first wireless device to a second wireless device according to a noise shaping scheme to shape distortion associated with crest factor reduction into one or more sets of frequency resources of a frequency band based on a channel estimate corresponding to the frequency band. The communications manager 1020 may be configured as or otherwise support a means for transmitting, to the second wireless device, control signaling including an indication of the noise shaping scheme. The communications manager 1020 may be configured as or otherwise support a means for transmitting the shaped waveform to the second wireless device via the frequency band based on the noise shaping scheme.

By including or configuring the communications manager 1020 in accordance with examples as described herein, the device 1005 may support techniques for channel-aware noise shaping, resulting in improved communication reliability, reduced power consumption, improved channel quality, decreased system latency, more efficient utilization of communication resources, and improved user experience.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of channel oriented noise shaping as described herein, or the processor 1040 and the memory 1030 may be otherwise configured to perform or support such operations.

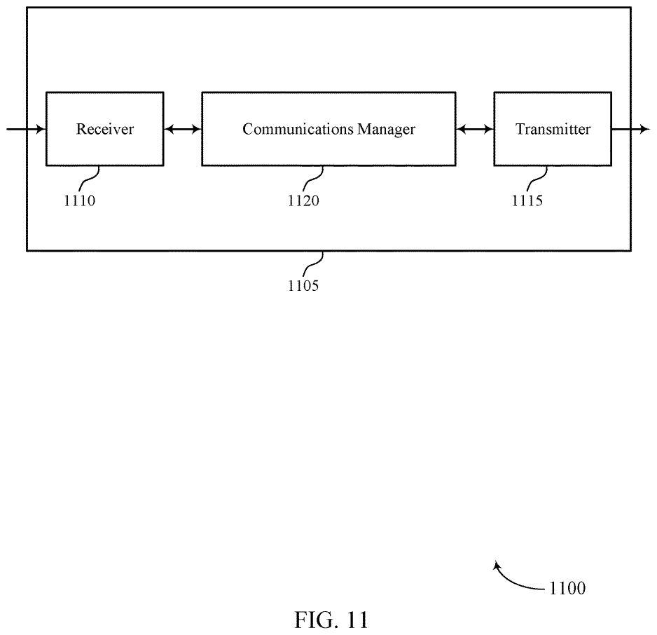

FIG. 11 illustrates a block diagram 1100 of a device 1105 that supports channel oriented noise shaping in accordance with one or more aspects of the present disclosure. The device 1105 may be an example of aspects of a receiving device as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations thereof or various components thereof may be examples of means for performing various aspects of channel oriented noise shaping as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. For example, the communications manager 1120 may be configured as or otherwise support a means for receiving, from a first wireless device by a second wireless device, control signaling including an indication of a noise shaping scheme. The communications manager 1120 may be configured as or otherwise support a means for receiving a shaped waveform from the first wireless device by the second wireless device via a frequency band. The communications manager 1120 may be configured as or otherwise support a means for decoding, based on the indication of the noise shaping scheme, the shaped waveform according to the noise shaping scheme that shapes distortion associated with crest factor reduction into one or more sets of frequency resources s of the frequency band based on a channel estimate corresponding to the frequency band.

By including or configuring the communications manager 1120 in accordance with examples as described herein, the device 1105 (e.g., a processor controlling or otherwise coupled with the receiver 1110, the transmitter 1115, the communications manager 1120, or a combination thereof) may support techniques for channel-aware noise shaping, resulting in reduced processing, reduced power consumption, improved channel quality, and more efficient utilization of communication resources.

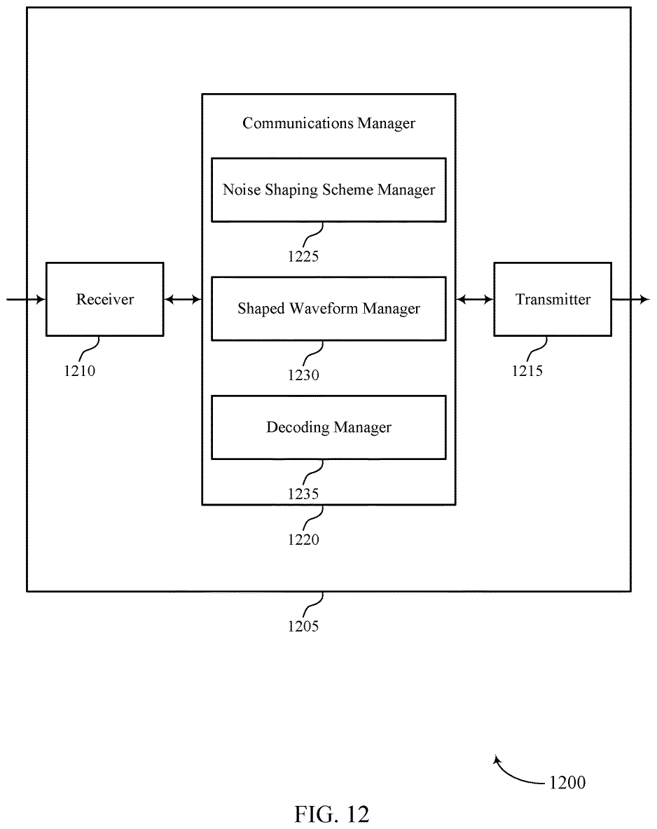

FIG. 12 illustrates a block diagram 1200 of a device 1205 that supports channel oriented noise shaping in accordance with one or more aspects of the present disclosure. The device 1205 may be an example of aspects of a device 1105 or a receiving device 115 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of channel oriented noise shaping as described herein. For example, the communications manager 1220 may include a noise shaping scheme manager 1225, a shaped waveform manager 1230, a decoding manager 1235, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. The noise shaping scheme manager 1225 may be configured as or otherwise support a means for receiving, from a first wireless device by a second wireless device, control signaling including an indication of a noise shaping scheme. The shaped waveform manager 1230 may be configured as or otherwise support a means for receiving a shaped waveform from the first wireless device by the second wireless device via a frequency band. The decoding manager 1235 may be configured as or otherwise support a means for decoding, based on the indication of the noise shaping scheme, the shaped waveform according to the noise shaping scheme that shapes distortion associated with crest factor reduction into one or more sets of frequency resources s of the frequency band based on a channel estimate corresponding to the frequency band.

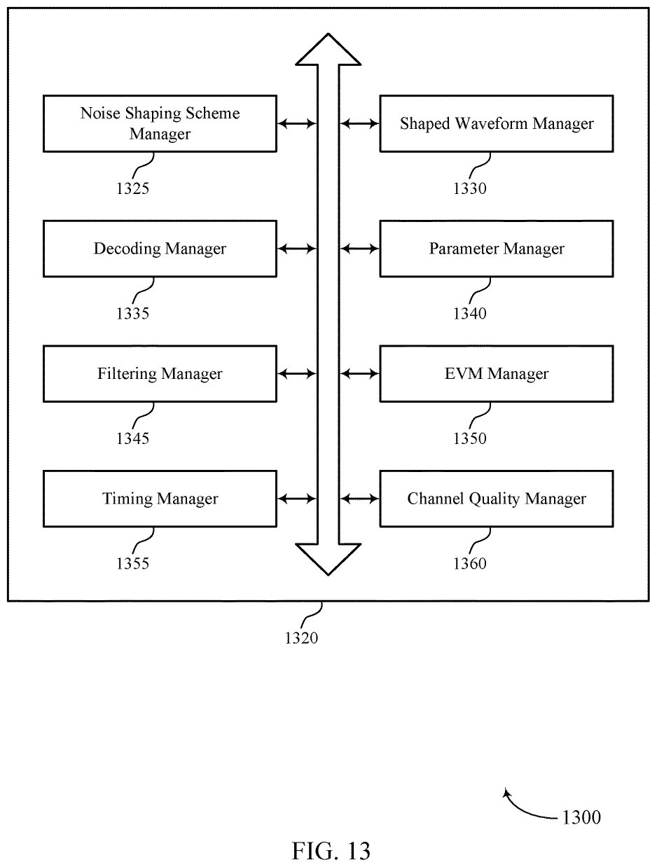

FIG. 13 illustrates a block diagram 1300 of a communications manager 1320 that supports channel oriented noise shaping in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of channel oriented noise shaping as described herein. For example, the communications manager 1320 may include a noise shaping scheme manager 1325, a shaped waveform manager 1330, a decoding manager 1335, a parameter manager 1340, a filtering manager 1345, a EVM manager 1350, a timing manager 1355, a channel quality manager 1360, or any combination thereof. Each of these components may communicate, directly or indirectly, with one another (e.g., via one or more buses).

The communications manager 1320 may support wireless communications in accordance with examples as disclosed herein. The noise shaping scheme manager 1325 may be configured as or otherwise support a means for receiving, from a first wireless device by a second wireless device, control signaling including an indication of a noise shaping scheme. The shaped waveform manager 1330 may be configured as or otherwise support a means for receiving a shaped waveform from the first wireless device by the second wireless device via a frequency band. The decoding manager 1335 may be configured as or otherwise support a means for decoding, based on the indication of the noise shaping scheme, the shaped waveform according to the noise shaping scheme that shapes distortion associated with crest factor reduction into one or more sets of frequency resources s of the frequency band based on a channel estimate corresponding to the frequency band.

In some examples, to support receiving the control signaling, the parameter manager 1340 may be configured as or otherwise support a means for receiving one or more parameters associated with the noise shaping scheme, the one or more parameters including an indication of a shaping filter, an indication of the one or more sets of frequency resources of the frequency band, a peak to average power ratio target, a number of iterations associated with the noise shaping scheme, a transmission power per symbol, or any combination thereof.

In some examples, to support receiving the control signaling, the filtering manager 1345 may be configured as or otherwise support a means for receiving a one-bit indication indicating that distortion filtering according to the noise shaping scheme is enabled.

In some examples, the EVM manager 1350 may be configured as or otherwise support a means for transmitting, to the first wireless device, an indication of a target error vector magnitude for each of a set of multiple sets of frequency resources including the one or more sets of frequency resources of the frequency band, where decoding the shaped waveform according to the noise shaping scheme is based on the indication of the target error vector magnitude for each of the set of multiple sets of frequency resources.

In some examples, distortion associated with the frequency band is shaped to the one or more sets of frequency resources based on a channel quality corresponding to the channel estimate.

In some examples, the channel quality manager 1360 may be configured as or otherwise support a means for receiving multiplexed transmissions via a first channel and a second channel, where the distortion is shaped to at least a portion of the one or more sets of frequency resources overlapping with the first channel according to a threshold error vector magnitude associated with the first channel, and the distortion is shaped to at least a portion of the one or more sets of frequency resources overlapping with the second channel according to a second threshold error vector magnitude associated with the second channel.

In some examples, to support receiving the shaped waveform, the shaped waveform manager 1330 may be configured as or otherwise support a means for receiving the shaped waveform according to a first modulation and coding scheme and a first error vector magnitude associated with a first set of one or more user equipments (UEs) including the second wireless device.

In some examples, the noise shaping scheme manager 1325 may be configured as or otherwise support a means for transmitting, to the first wireless device, control signaling including an indication of the one or more sets of frequency resources, a first modulation and coding scheme and a second modulation and coding scheme, and a first error vector magnitude and a second error vector magnitude, where the first wireless device includes a UE and the second wireless device includes a network entity.

In some examples, to support receiving the shaped waveform, the shaped waveform manager 1330 may be configured as or otherwise support a means for receiving a first portion of the shaped waveform according to the first modulation and coding scheme and the first error vector magnitude. In some examples, to support receiving the shaped waveform, the shaped waveform manager 1330 may be configured as or otherwise support a means for receiving a second portion of the shaped waveform according to the second modulation and coding scheme and the second error vector magnitude.

In some examples, the timing manager 1355 may be configured as or otherwise support a means for aligning reception of a first portion of the shaped waveform via the one or more sets of frequency resources associated with a first error vector magnitude to a first resource block group boundary and reception of a second portion of the shaped waveform via one or more additional sets of frequency resources associated with a second error vector magnitude to a second resource block group boundary, where receiving the shaped waveform is based on the aligning.

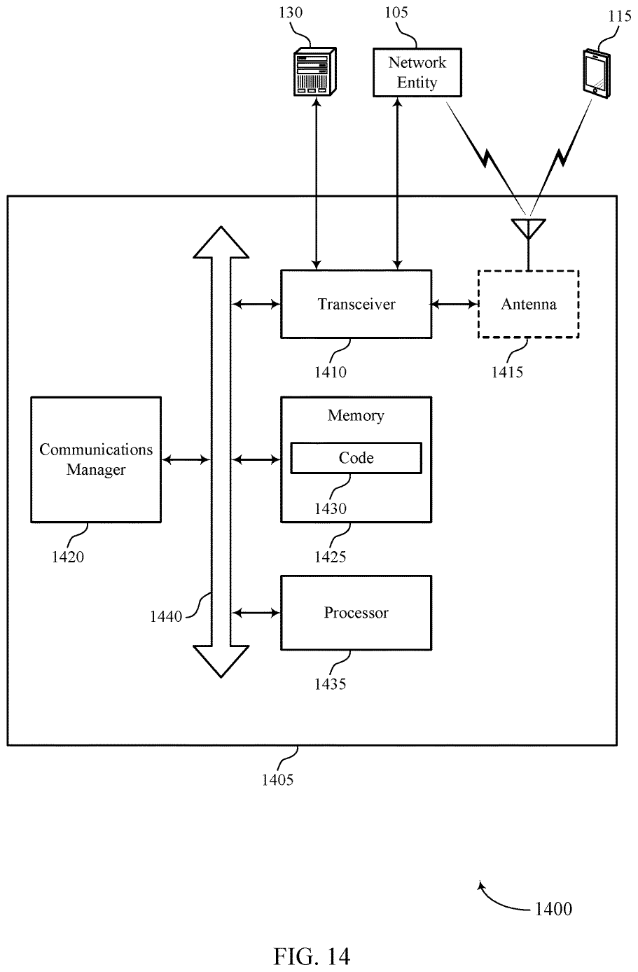

FIG. 14 illustrates a diagram of a system 1400 including a device 1405 that supports channel oriented noise shaping in accordance with one or more aspects of the present disclosure. The device 1405 may be an example of or include the components of a device 1105, a device 1205, or a receiving device as described herein. The device 1405 may include components for bi-directional voice and data communications including components for transmitting and receiving communications, such as a communications manager 1420, a transceiver 1410, an antenna 1415, a memory 1425, code 1430, and a processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or memory components (for example, the processor 1435, or the memory 1425, or both), may be included in a chip or chip assembly that is installed in the device 1405. In some examples, the transceiver may be operable to support communications via one or more communications links (e.g., a communication link 125, a backhaul communication link 120, a midhaul communication link 162, a fronthaul communication link 168).

The memory 1425 may include RAM and ROM. The memory 1425 may store computer-readable, computer-executable code 1430 including instructions that, when executed by the processor 1435, cause the device 1405 to perform various functions described herein. The code 1430 may be stored in a non-transitory computer-readable medium such as system memory or another type of memory. In some cases, the code 1430 may not be directly executable by the processor 1435 but may cause a computer (e.g., when compiled and executed) to perform functions described herein. In some cases, the memory 1425 may contain, among other things, a BIOS which may control basic hardware or software operation such as the interaction with peripheral components or devices.

The processor 1435 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1435 may be configured to operate a memory array using a memory controller. In some other cases, a memory controller may be integrated into the processor 1435. The processor 1435 may be configured to execute computer-readable instructions stored in a memory (e.g., the memory 1425) to cause the device 1405 to perform various functions (e.g., functions or tasks supporting channel oriented noise shaping). For example, the device 1405 or a component of the device 1405 may include a processor 1435 and memory 1425 coupled with the processor 1435, the processor 1435 and memory 1425 configured to perform various functions described herein. The processor 1435 may be an example of a cloud-computing platform (e.g., one or more physical nodes and supporting software such as operating systems, virtual machines, or container instances) that may host the functions (e.g., by executing code 1430) to perform the functions of the device 1405. The processor 1435 may be any one or more suitable processors capable of executing scripts or instructions of one or more software programs stored in the device 1405 (such as within the memory 1425). In some implementations, the processor 1435 may be a component of a processing system. A processing system may generally refer to a system or series of machines or components that receives inputs and processes the inputs to produce a set of outputs (which may be passed to other systems or components of, for example, the device 1405). For example, a processing system of the device 1405 may refer to a system including the various other components or subcomponents of the device 1405, such as the processor 1435, or the transceiver 1410, or the communications manager 1420, or other components or combinations of components of the device 1405. The processing system of the device 1405 may interface with other components of the device 1405, and may process information received from other components (such as inputs or signals) or output information to other components. For example, a chip or modem of the device 1405 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1405 may transmit information output from the chip or modem. Additionally, or alternatively, in some implementations, the one or more interfaces may refer to an interface between the processing system of the chip or modem and a receiver, such that the device 1405 may obtain information or signal inputs, and the information may be passed to the processing system. A person having ordinary skill in the art will readily recognize that a first interface also may obtain information or signal inputs, and a second interface also may output information or signal outputs.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the memory 1425, the code 1430, and the processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network entities 105, and may include a controller or scheduler for controlling communications with UEs 115 in cooperation with other network entities 105. In some examples, the communications manager 1420 may support an X2 interface within an LTE/LTE-A wireless communications network technology to provide communication between network entities 105.

The communications manager 1420 may support wireless communications in accordance with examples as disclosed herein. For example, the communications manager 1420 may be configured as or otherwise support a means for receiving, from a first wireless device by a second wireless device, control signaling including an indication of a noise shaping scheme. The communications manager 1420 may be configured as or otherwise support a means for receiving a shaped waveform from the first wireless device by the second wireless device via a frequency band. The communications manager 1420 may be configured as or otherwise support a means for decoding, based on the indication of the noise shaping scheme, the shaped waveform according to the noise shaping scheme that shapes distortion associated with crest factor reduction into one or more sets of frequency resources s of the frequency band based on a channel estimate corresponding to the frequency band.

By including or configuring the communications manager 1420 in accordance with examples as described herein, the device 1405 may support techniques for channel-aware noise shaping, resulting in improved communication reliability, reduced power consumption, improved channel quality, decreased system latency, more efficient utilization of communication resources, and improved user experience.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, the processor 1435, the memory 1425, the code 1430, or any combination thereof. For example, the code 1430 may include instructions executable by the processor 1435 to cause the device 1405 to perform various aspects of channel oriented noise shaping as described herein, or the processor 1435 and the memory 1425 may be otherwise configured to perform or support such operations.

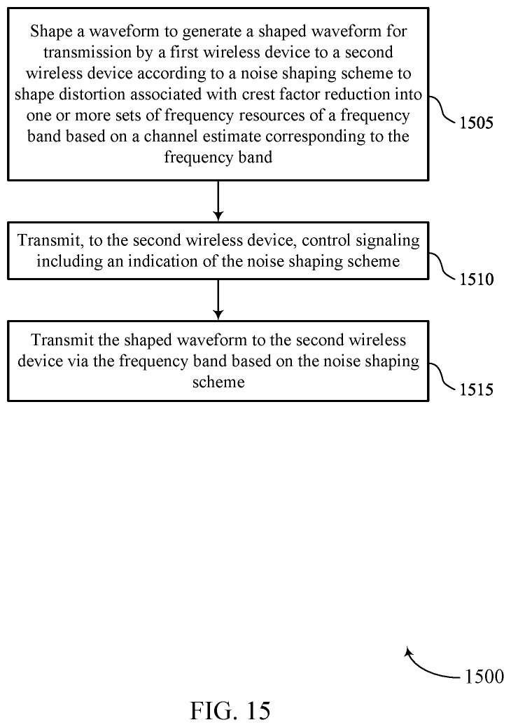

FIG. 15 illustrates a flowchart showing a method 1500 that supports channel oriented noise shaping in accordance with one or more aspects of the present disclosure. The operations of the method 1500 may be implemented by a transmitting device or its components as described herein. For example, the operations of the method 1500 may be performed by a transmitting device as described with reference to FIGS. 1 through 10. In some examples, a transmitting device may execute a set of instructions to control the functional elements of the transmitting device to perform the described functions. Additionally, or alternatively, the transmitting device may perform aspects of the described functions using special-purpose hardware.

At 1505, the method may include shaping a waveform to generate a shaped waveform for transmission by a first wireless device to a second wireless device according to a noise shaping scheme to shape distortion associated with crest factor reduction into one or more sets of frequency resources of a frequency band based on a channel estimate corresponding to the frequency band. The operations of 1505 may be performed in accordance with examples as disclosed herein. In some examples, aspects of the operations of 1505 may be performed by a shaping component 925 as described with reference to FIG. 9.

At 1510, the method may include transmitting, to the second wireless device, control signaling including an indication of the noise shaping scheme. The operations of 1510 may be performed in accordance with examples as disclosed herein. In some examples, aspects of the operations of 1510 may be performed by a noise shaping scheme manager 930 as described with reference to FIG. 9.

At 1515, the method may include transmitting the shaped waveform to the second wireless device via the frequency band based on the noise shaping scheme. The operations of 1515 may be performed in accordance with examples as disclosed herein. In some examples, aspects of the operations of 1515 may be performed by a shaped waveform manager 935 as described with reference to FIG. 9.

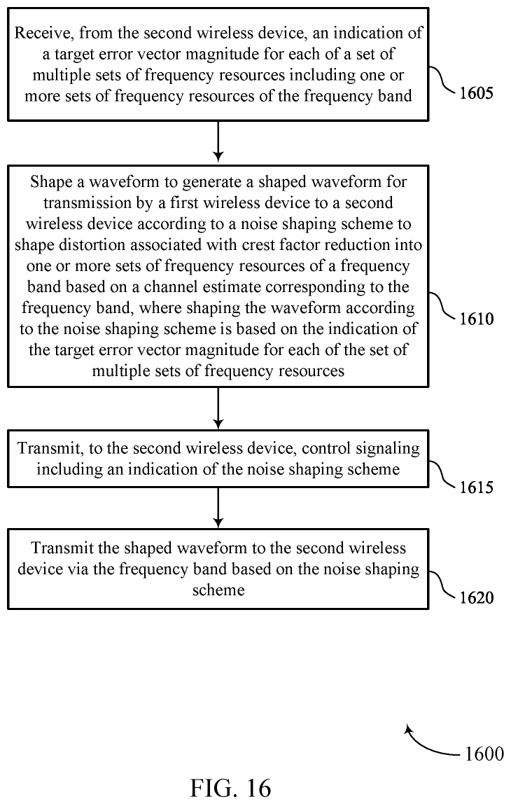

FIG. 16 illustrates a flowchart showing a method 1600 that supports channel oriented noise shaping in accordance with one or more aspects of the present disclosure. The operations of the method 1600 may be implemented by a transmitting device or its components as described herein. For example, the operations of the method 1600 may be performed by a transmitting device as described with reference to FIGS. 1 through 10. In some examples, a transmitting device may execute a set of instructions to control the functional elements of the transmitting device to perform the described functions. Additionally, or alternatively, the transmitting device may perform aspects of the described functions using special-purpose hardware.

At 1605, the method may include receiving, from the second wireless device, an indication of a target error vector magnitude for each of a set of multiple sets of frequency resources including one or more sets of frequency resources of the frequency band. The operations of 1605 may be performed in accordance with examples as disclosed herein. In some examples, aspects of the operations of 1605 may be performed by a target EVM manager 940 as described with reference to FIG. 9.

At 1610, the method may include shaping a waveform to generate a shaped waveform for transmission by a first wireless device to a second wireless device according to a noise shaping scheme to shape distortion associated with crest factor reduction into one or more sets of frequency resources of a frequency band based on a channel estimate corresponding to the frequency band, where shaping the waveform according to the noise shaping scheme is based on the indication of the target error vector magnitude for each of the set of multiple sets of frequency resources. The operations of 1610 may be performed in accordance with examples as disclosed herein. In some examples, aspects of the operations of 1610 may be performed by a shaping component 925 as described with reference to FIG. 9.

At 1615, the method may include transmitting, to the second wireless device, control signaling including an indication of the noise shaping scheme. The operations of 1615 may be performed in accordance with examples as disclosed herein. In some examples, aspects of the operations of 1615 may be performed by a noise shaping scheme manager 930 as described with reference to FIG. 9.

At 1620, the method may include transmitting the shaped waveform to the second wireless device via the frequency band based on the noise shaping scheme. The operations of 1620 may be performed in accordance with examples as disclosed herein. In some examples, aspects of the operations of 1620 may be performed by a shaped waveform manager 935 as described with reference to FIG. 9.

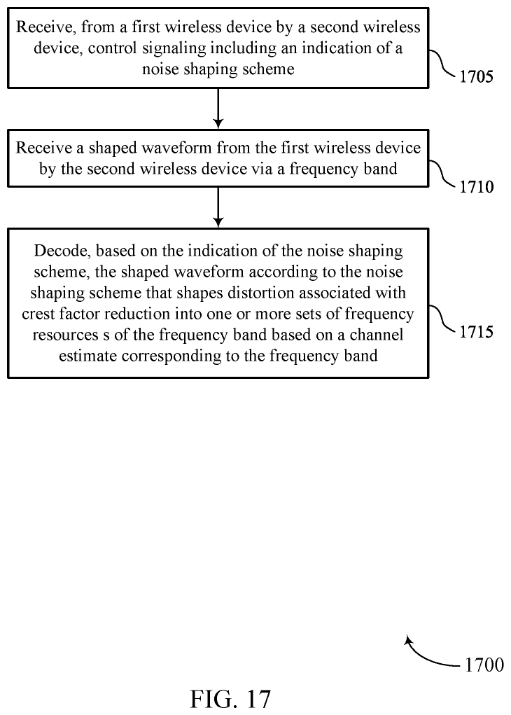

FIG. 17 illustrates a flowchart showing a method 1700 that supports channel oriented noise shaping in accordance with one or more aspects of the present disclosure. The operations of the method 1700 may be implemented by a receiving device or its components as described herein. For example, the operations of the method 1700 may be performed by a receiving device as described with reference to FIGS. 1 through 6 and 11 through 14. In some examples, a receiving device may execute a set of instructions to control the functional elements of the receiving device to perform the described functions. Additionally, or alternatively, the receiving device may perform aspects of the described functions using special-purpose hardware.

At 1705, the method may include receiving, from a first wireless device by a second wireless device, control signaling including an indication of a noise shaping scheme. The operations of 1705 may be performed in accordance with examples as disclosed herein. In some examples, aspects of the operations of 1705 may be performed by a noise shaping scheme manager 1325 as described with reference to FIG. 13.

At 1710, the method may include receiving a shaped waveform from the first wireless device by the second wireless device via a frequency band. The operations of 1710 may be performed in accordance with examples as disclosed herein. In some examples, aspects of the operations of 1710 may be performed by a shaped waveform manager 1330 as described with reference to FIG. 13.

At 1715, the method may include decoding, based on the indication of the noise shaping scheme, the shaped waveform according to the noise shaping scheme that shapes distortion associated with crest factor reduction into one or more sets of frequency resources s of the frequency band based on a channel estimate corresponding to the frequency band. The operations of 1715 may be performed in accordance with examples as disclosed herein. In some examples, aspects of the operations of 1715 may be performed by a decoding manager 1335 as described with reference to FIG. 13.

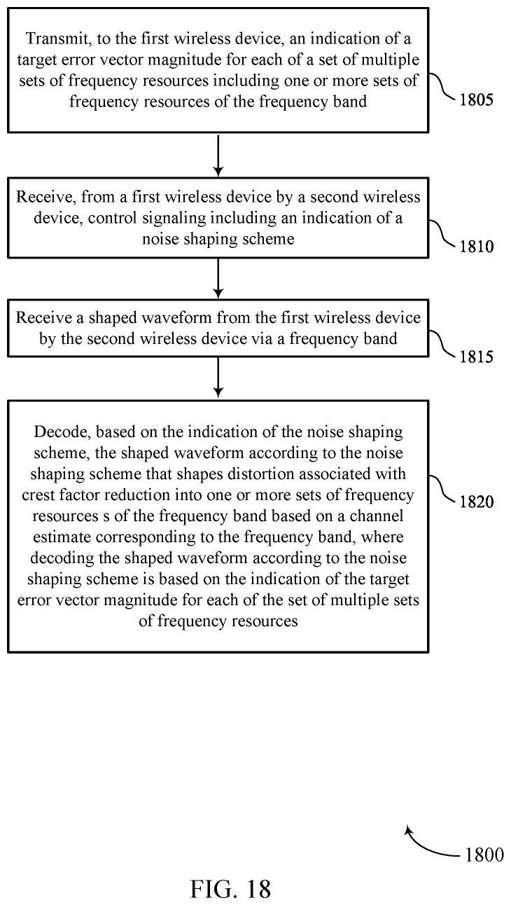

FIG. 18 illustrates a flowchart showing a method 1800 that supports channel oriented noise shaping in accordance with one or more aspects of the present disclosure. The operations of the method 1800 may be implemented by a receiving device or its components as described herein. For example, the operations of the method 1800 may be performed by a receiving device as described with reference to FIGS. 1 through 6 and 11 through 14. In some examples, a receiving device may execute a set of instructions to control the functional elements of the receiving device to perform the described functions. Additionally, or alternatively, the receiving device may perform aspects of the described functions using special-purpose hardware.

At 1805, the method may include transmitting, to the first wireless device, an indication of a target error vector magnitude for each of a set of multiple sets of frequency resources including the one or more sets of frequency resources of the frequency band. The operations of 1805 may be performed in accordance with examples as disclosed herein. In some examples, aspects of the operations of 1805 may be performed by a EVM manager 1350 as described with reference to FIG. 13.

At 1810, the method may include receiving, from a first wireless device by a second wireless device, control signaling including an indication of a noise shaping scheme. The operations of 1810 may be performed in accordance with examples as disclosed herein. In some examples, aspects of the operations of 1810 may be performed by a noise shaping scheme manager 1325 as described with reference to FIG. 13.

At 1815, the method may include receiving a shaped waveform from the first wireless device by the second wireless device via a frequency band. The operations of 1815 may be performed in accordance with examples as disclosed herein. In some examples, aspects of the operations of 1815 may be performed by a shaped waveform manager 1330 as described with reference to FIG. 13.

At 1820, the method may include decoding, based on the indication of the noise shaping scheme, the shaped waveform according to the noise shaping scheme that shapes distortion associated with crest factor reduction into one or more sets of frequency resources s of the frequency band based on a channel estimate corresponding to the frequency band, where decoding the shaped waveform according to the noise shaping scheme is based on the indication of the target error vector magnitude for each of the set of multiple sets of frequency resources. The operations of 1820 may be performed in accordance with examples as disclosed herein. In some examples, aspects of the operations of 1820 may be performed by a decoding manager 1335 as described with reference to FIG. 13.

The following provides an overview of aspects of the present disclosure:

Aspect 1: A method for wireless communications, comprising: shaping a waveform to generate a shaped waveform for transmission by a first wireless device to a second wireless device according to a noise shaping scheme to shape distortion associated with crest factor reduction into one or more sets of frequency resources of a frequency band based at least in part on a channel estimate corresponding to the frequency band; transmitting, to the second wireless device, control signaling comprising an indication of the noise shaping scheme; and transmitting the shaped waveform to the second wireless device via the frequency band based at least in part on the noise shaping scheme.

Aspect 2: The method of aspect 1, wherein transmitting the control signaling comprises: transmitting one or more parameters associated with the noise shaping scheme, the one or more parameters comprising an indication of a shaping filter, an indication of the one or more sets of frequency resources of the frequency band, a peak to average power ratio target, a number of iterations associated with the noise shaping scheme, a transmission power per symbol, or any combination thereof.

Aspect 3: The method of any of aspects 1 through 2, wherein transmitting the control signaling comprises: transmitting a one-bit indication indicating that distortion filtering according to the noise shaping scheme is enabled.

Aspect 4: The method of any of aspects 1 through 3, further comprising: receiving, from the second wireless device, an indication of a target error vector magnitude for each of a plurality of sets of frequency resources comprising the one or more sets of frequency resources of the frequency band, wherein shaping the waveform according to the noise shaping scheme is based at least in part on the indication of the target error vector magnitude for each of the plurality of sets of frequency resources.

Aspect 5: The method of any of aspects 1 through 4, wherein shaping the waveform comprises: identifying, based at least in part on the channel estimate, that channel quality corresponding to the one or more sets of frequency resources is lower than channel quality corresponding to one or more additional sets of frequency resources of the frequency band; and shaping distortion associated with the frequency band to the one or more sets of frequency resources based at least in part on the identifying according to the noise shaping scheme.

Aspect 6: The method of any of aspects 1 through 5, further comprising: multiplexing transmissions via a first channel and a second channel, wherein shaping the distortion comprises shaping the distortion to at least a portion of the one or more sets of frequency resources overlapping with the first channel according to a threshold error vector magnitude associated with the first channel.

Aspect 7: The method of aspect 6, wherein shaping the distortion further comprises: shaping the distortion to at least a portion of the one or more sets of frequency resources overlapping with the second channel according to a second threshold error vector magnitude associated with the second channel.

Aspect 8: The method of any of aspects 6 through 7, wherein the first channel comprises a physical downlink control channel and the second channel comprises a physical downlink shared channel, and the first wireless device comprises a network entity.

Aspect 9: The method of any of aspects 6 through 8, wherein the first channel comprises a physical uplink control channel and the second channel comprises a physical uplink shared channel, and the first wireless device comprises a UE.

Aspect 10: The method of any of aspects 1 through 9, wherein transmitting the waveform comprises: transmitting at least a portion of the waveform to a first set of one or more user equipments (UEs) via the one or more sets of frequency resources according to a first error vector magnitude, a first modulation and coding scheme, or both; and transmitting at least a portion of the waveform to a second set of one or more UEs via one or more additional sets of frequency resources of the frequency band according to second error vector magnitude, a second modulation and coding scheme, or both.

Aspect 11: The method of any of aspects 1 through 10, further comprising: receiving, from the second wireless device, control signaling comprising an indication of the one or more sets of frequency resources, a first modulation and coding scheme corresponding to a first error vector magnitude and a second modulation and coding scheme corresponding to a second error vector magnitude, wherein the first wireless device comprises a UE and the second wireless device comprises a network entity.

Aspect 12: The method of aspect 11, wherein transmitting the waveform comprises: transmitting a first portion of the waveform according to the first modulation and coding scheme and the first error vector magnitude; and transmitting a second portion of the waveform according to the second modulation and coding scheme and the second error vector magnitude.

Aspect 13: The method of any of aspects 1 through 12, further comprising: aligning transmission of a first portion of the waveform via the one or more sets of frequency resources associated with a first error vector magnitude to a first resource block group boundary and transmission of a second portion of the waveform via one or more additional associated with a second error vector magnitude to a second resource block group boundary, wherein transmitting the waveform is based at least in part on the aligning.

Aspect 14: A method for wireless communications, comprising: receiving, from a first wireless device by a second wireless device, control signaling comprising an indication of a noise shaping scheme; receiving a shaped waveform from the first wireless device by the second wireless device via a frequency band; and decoding, based at least in part on the indication of the noise shaping scheme, the shaped waveform according to the noise shaping scheme that shapes distortion associated with crest factor reduction into one or more sets of frequency resources s of the frequency band based at least in part on a channel estimate corresponding to the frequency band.

Aspect 15: The method of aspect 14, wherein receiving the control signaling comprises: receiving one or more parameters associated with the noise shaping scheme, the one or more parameters comprising an indication of a shaping filter, an indication of the one or more sets of frequency resources of the frequency band, a peak to average power ratio target, a number of iterations associated with the noise shaping scheme, a transmission power per symbol, or any combination thereof.

Aspect 16: The method of any of aspects 14 through 15, wherein receiving the control signaling comprises: receiving a one-bit indication indicating that distortion filtering according to the noise shaping scheme is enabled.

Aspect 17: The method of any of aspects 14 through 16, further comprising: transmitting, to the first wireless device, an indication of a target error vector magnitude for each of a plurality of sets of frequency resources comprising the one or more sets of frequency resources of the frequency band, wherein decoding the shaped waveform according to the noise shaping scheme is based at least in part on the indication of the target error vector magnitude for each of the plurality of sets of frequency resources.

Aspect 18: The method of any of aspects 14 through 17, wherein distortion associated with the frequency band is shaped to the one or more sets of frequency resources based at least in part on a channel quality corresponding to the channel estimate.

Aspect 19: The method of aspect 18, further comprising: receiving multiplexed transmissions via a first channel and a second channel, wherein the distortion is shaped to at least a portion of the one or more sets of frequency resources overlapping with the first channel according to a threshold error vector magnitude associated with the first channel, and the distortion is shaped to at least a portion of the one or more sets of frequency resources overlapping with the second channel according to a second threshold error vector magnitude associated with the second channel.

Aspect 20: The method of any of aspects 14 through 19, wherein receiving the shaped waveform comprises: receiving the shaped waveform according to a first modulation and coding scheme and a first error vector magnitude associated with a first set of one or more user equipments (UEs) comprising the second wireless device.

Aspect 21: The method of any of aspects 14 through 20, further comprising: transmitting, to the first wireless device, control signaling comprising an indication of the one or more sets of frequency resources, a first modulation and coding scheme and a second modulation and coding scheme, and a first error vector magnitude and a second error vector magnitude, wherein the first wireless device comprises a UE and the second wireless device comprises a network entity.

Aspect 22: The method of aspect 21, wherein receiving the shaped waveform comprises: receiving a first portion of the shaped waveform according to the first modulation and coding scheme and the first error vector magnitude; and receiving a second portion of the shaped waveform according to the second modulation and coding scheme and the second error vector magnitude.

Aspect 23: The method of any of aspects 14 through 22, further comprising: aligning reception of a first portion of the shaped waveform via the one or more sets of frequency resources associated with a first error vector magnitude to a first resource block group boundary and reception of a second portion of the shaped waveform via one or more additional sets of frequency resources associated with a second error vector magnitude to a second resource block group boundary, wherein receiving the shaped waveform is based at least in part on the aligning.

Aspect 24: An apparatus for wireless communications, comprising a processor; memory coupled with the processor; and instructions stored in the memory and executable by the processor to cause the apparatus to perform a method of any of aspects 1 through 13.

Aspect 25: An apparatus for wireless communications, comprising at least one means for performing a method of any of aspects 1 through 13.

Aspect 26: A non-transitory computer-readable medium storing code for wireless communications, the code comprising instructions executable by a processor to perform a method of any of aspects 1 through 13.

Aspect 27: An apparatus for wireless communications, comprising a processor; memory coupled with the processor; and instructions stored in the memory and executable by the processor to cause the apparatus to perform a method of any of aspects 14 through 23.

Aspect 28: An apparatus for wireless communications, comprising at least one means for performing a method of any of aspects 14 through 23.

Aspect 29: A non-transitory computer-readable medium storing code for wireless communications, the code comprising instructions executable by a processor to perform a method of any of aspects 14 through 23.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communications, comprising:
a processor;
memory coupled with the processor; and
instructions stored in the memory and executable by the processor to cause the apparatus to:
shape a waveform to generate a shaped waveform for transmission by a first wireless device to a second wireless device according to a noise shaping scheme to shape distortion associated with crest factor reduction into one or more sets of frequency resources of a frequency band based at least in part on a channel estimate corresponding to the frequency band;
transmit, to the second wireless device, control signaling comprising an indication of the noise shaping scheme; and
transmit the shaped waveform to the second wireless device via the frequency band based at least in part on the noise shaping scheme.

2. The apparatus of claim 1, wherein the instructions to transmit the control signaling are executable by the processor to cause the apparatus to:
transmit one or more parameters associated with the noise shaping scheme, the one or more parameters comprising an indication of a shaping filter, an indication of the one or more sets of frequency resources of the frequency band, a peak to average power ratio target, a number of iterations associated with the noise shaping scheme, a transmission power per symbol, or any combination thereof.

3. The apparatus of claim 1, wherein the instructions to transmit the control signaling are executable by the processor to cause the apparatus to:
transmit a one-bit indication indicating that distortion filtering according to the noise shaping scheme is enabled.

4. The apparatus of claim 1, wherein the instructions are further executable by the processor to cause the apparatus to:
receive, from the second wireless device, an indication of a target error vector magnitude for each of a plurality of sets of frequency resources comprising the one or more sets of frequency resources of the frequency band, wherein shaping the waveform according to the noise shaping scheme is based at least in part on the indication of the target error vector magnitude for each of the plurality of sets of frequency resources.

5. The apparatus of claim 1, wherein the instructions to shape the waveform are executable by the processor to cause the apparatus to:
identifying, base at least in part on the channel estimate, that channel quality corresponding to the one or more sets of frequency resources is lower than channel quality corresponding to one or more additional sets of frequency resources of the frequency band; and
shaping distortion associate with the frequency band to the one or more sets of frequency resources based at least in part on the identifying according to the noise shaping scheme.

6. The apparatus of claim 1, wherein the instructions are further executable by the processor to cause the apparatus to:
multiplex transmissions via a first channel and a second channel, wherein shaping the distortion comprises shaping the distortion to at least a portion of the one or more sets of frequency resources overlapping with the first channel according to a threshold error vector magnitude associated with the first channel.

7. The apparatus of claim 6, wherein the instructions to shape the distortion are further executable by the processor to cause the apparatus to:
shape the distortion to at least a portion of the one or more sets of frequency resources overlapping with the second channel according to a second threshold error vector magnitude associated with the second channel.

8. The apparatus of claim 6, wherein the first channel comprises a physical downlink control channel and the second channel comprises a physical downlink shared channel, and the first wireless device comprises a network entity.

9. The apparatus of claim 6, wherein the first channel comprises a physical uplink control channel and the second channel comprises a physical uplink shared channel, and the first wireless device comprises a user equipment (UE).

10. The apparatus of claim 1, wherein the instructions to transmit the waveform are executable by the processor to cause the apparatus to:
transmit at least a portion of the waveform to a first set of one or more user equipments (UEs) via the one or more sets of frequency resources according to a first error vector magnitude, a first modulation and coding scheme, or both; and transmit at least a portion of the waveform to a second set of one or more UEs via one or more additional sets of frequency resources of the frequency band according to second error vector magnitude, a second modulation and coding scheme, or both.

11. The apparatus of claim 1, wherein the instructions are further executable by the processor to cause the apparatus to:
receive, from the second wireless device, control signaling comprising an indication of the one or more sets of frequency resources, a first modulation and coding scheme corresponding to a first error vector magnitude and a second modulation and coding scheme corresponding to a second error vector magnitude, wherein the first wireless device comprises a user equipment (UE) and the second wireless device comprises a network entity.

12. The apparatus of claim 11, wherein the instructions to transmit the waveform are executable by the processor to cause the apparatus to:
transmit a first portion of the waveform according to the first modulation and coding scheme and the first error vector magnitude; and
transmit a second portion of the waveform according to the second modulation and coding scheme and the second error vector magnitude.

13. The apparatus of claim 1, wherein the instructions are further executable by the processor to cause the apparatus to:
align transmission of a first portion of the waveform via the one or more sets of frequency resources associated with a first error vector magnitude to a first resource block group boundary and transmission of a second portion of the waveform via one or more additional associated with a second error vector magnitude to a second resource block group boundary, wherein transmitting the waveform is based at least in part on the aligning.

14. An apparatus for wireless communications, comprising:
a processor;
memory coupled with the processor; and
instructions stored in the memory and executable by the processor to cause the apparatus to:
receive, from a first wireless device by a second wireless device, control signaling comprising an indication of a noise shaping scheme;
receive a shaped waveform from the first wireless device by the second wireless device via a frequency band; and
decode, based at least in part on the indication of the noise shaping scheme, the shaped waveform according to the noise shaping scheme that shapes distortion associated with crest factor reduction into one or more sets of frequency resources s of the frequency band based at least in part on a channel estimate corresponding to the frequency band.

15. The apparatus of claim 14, wherein the instructions to receive the control signaling are executable by the processor to cause the apparatus to:
receive one or more parameters associated with the noise shaping scheme, the one or more parameters comprising an indication of a shaping filter, an indication of the one or more sets of frequency resources of the frequency band, a peak to average power ratio target, a number of iterations associated with the noise shaping scheme, a transmission power per symbol, or any combination thereof.

16. The apparatus of claim 14, wherein the instructions to receive the control signaling are executable by the processor to cause the apparatus to:
receive a one-bit indication indicating that distortion filtering according to the noise shaping scheme is enabled.

17. The apparatus of claim 14, wherein the instructions are further executable by the processor to cause the apparatus to:
transmit, to the first wireless device, an indication of a target error vector magnitude for each of a plurality of sets of frequency resources comprising the one or more sets of frequency resources of the frequency band, wherein decoding the shaped waveform according to the noise shaping scheme is based at least in part on the indication of the target error vector magnitude for each of the plurality of sets of frequency resources.

18. The apparatus of claim 14, wherein distortion associated with the frequency band is shaped to the one or more sets of frequency resources based at least in part on a channel quality corresponding to the channel estimate.

19. The apparatus of claim 18, wherein the instructions are further executable by the processor to cause the apparatus to:
receive multiplexed transmissions via a first channel and a second channel, wherein the distortion is shaped to at least a portion of the one or more sets of frequency resources overlapping with the first channel according to a threshold error vector magnitude associated with the first channel, and the distortion is shaped to at least a portion of the one or more sets of frequency resources overlapping with the second channel according to a second threshold error vector magnitude associated with the second channel.

20.-23. (canceled)

24. A method for wireless communications, comprising: shaping a waveform to generate a shaped waveform for transmission by a first wireless device to a second wireless device according to a noise shaping scheme to shape distortion associated with crest factor reduction into one or more sets of frequency resources of a frequency band based at least in part on a channel estimate corresponding to the frequency band;
transmitting, to the second wireless device, control signaling comprising an indication of the noise shaping scheme; and
transmitting the shaped waveform to the second wireless device via the frequency band based at least in part on the noise shaping scheme.

25.-30. (canceled)
